(19) United States
(12) Patent Application Publication
(10) Pub. No.: US 2017/0234966 A1
(43) Pub. Date: Aug. 17, 2017

(54) DEVICE FOR UAV DETECTION AND IDENTIFICATION

(71) Applicant: QUALCOMM Incorporated, San Diego, CA (US)

(72) Inventors: Ayman Naguib, Cupertino, CA (US); Michael Taveira, San Diego, CA (US); Nayeem Islam, Palo Alto, CA (US)

(21) Appl. No.: 15/283,247

(22) Filed: Sep. 30, 2016

Related U.S. Application Data
(63) Continuation-in-part of application No. 15/046,390, filed on Feb. 17, 2016.

(51) Int. Cl. G01S 5/22; G01H 3/08; G01S 5/30

(52) U.S. Cl. CPC G01S 5/22; G01S 5/30; G01H 3/08

(57) ABSTRACT

Apparatuses and methods are described herein for identifying an Unmanned Aerial Vehicle (UAV) by a central server connected to a first detection device and a plurality of detection devices, including, but not limited to, receiving, by the central server, information related to the UAV from the first detection device, selecting, by the central server, a second detection device from a plurality of detection devices connected to the central server, and sending, by the central server, the information to the second detection device.

### CROSS-REFERENCE TO RELATED PATENT APPLICATIONS

This application is a Continuation-In-Part of U.S. application Ser. No. 15/046,390, filed Feb. 17, 2016, which is incorporated herein by reference in its entirety.

### BACKGROUND

A variety of Unmanned Aerial Vehicles (UAVs) have been developed, including Remote Control (RC) planes for the hobbyists, and more advanced “drones” or UAVs. Various UAV configurations and features, including for example, various “quadcopter” or four-rotor configurations, have been developed for various hobby, commercial, or military applications.

As UAVs become more sophisticated and more easily accessible, unregulated use of UAVs may pose security, safety, and privacy concerns. For example, unregulated use of UAVs can include invasion of privacy, espionage, smuggling, and the like. In certain contexts, detection of UAVs can be challenging, given that UAVs can be much smaller than manned aircrafts, can fly at low altitudes, and can maneuver differently than manned aircrafts. Standard radar and other conventional technologies for detecting larger, manned aircrafts may not be well-suited for detecting UAVs. For example, pulsed radars cannot detect UAVs as the pulsed radars have a minimum range and resolution, severely limiting detection and identification of small UAVs. Some existing solutions, including micro-Synthetic Aperture Radar (SAR), Nano-SAR, and Miniature Radar Altimeter (MRA), were designed for remote sensing applications instead of detecting and identifying UAVs, and additional work is necessary before such solutions can be used reliably to detect small UAVs.

### SUMMARY

Various examples relate to detecting and identifying Unmanned Aerial Vehicles (UAVs). The detection and identification examples can be implemented to distinguish a UAV from other UAVs or other flying objects (such as, but not limited to, avian animals). An approaching UAV may generate acoustic sound (via rotors) that may correspond to a particular acoustic signature. An acoustic signature delta may be determined from a first acoustic signature and a second acoustic signature. The first acoustic signature may correspond to a first maneuver of the UAV. The second acoustic signature may correspond to a second maneuver of the UAV. The acoustic signature delta may be correlated with acoustic signature deltas of various types of UAVs for determining a matching UAV identity. The UAV may accordingly be identified based on the correlation.

In a similar fashion, an approaching UAV may exhibit motion patterns (in a video stream) that are specifically distinguishable from the motion patterns of other flying objects (such as, but not limited to, avian animals). Those motion patterns may correspond to a particular maneuver performed by the UAV.

In further examples, in addition to using the acoustic-based identification process and a video/image-based identification process, a fusion engine may correlate one or more of acoustic sound data, video/image data, infrared/thermal data, radar data, or intercepted wireless control communication data associated with the approaching UAV to determine the identity of the approaching UAV. Particularly, the fusion engine may correlate the different types of data based on timestamps to determine the identity of the UAV with higher confidence level.

According to some examples, a method for managing detection and identification of an Unmanned Aerial Vehicle (UAV) includes determining, by a first detection device configured to detect the UAV in a first detection area, information related to the UAV, and sending, by the first detection device, the information to a second detection device configured to detect the UAV in a second detection area for determining an identity of the UAV.

In some examples, the first detection area is adjacent to or overlapping with the second detection area.

In some examples, the method further includes determining one or more of a position, speed, direction, or altitude of the UAV, and selecting the second detection device from a plurality of adjacent detection devices based on the one or more of the position, speed, direction, or altitude of the UAV.

In some examples, the method further includes determining an Estimated Time of Arrival (ETA) of the UAV for reaching the second detection area of the second detection device, wherein the information is sent to the second detection device based on the ETA.

In some examples, the method further includes selecting the second detection device from a plurality of adjacent detection devices, and determining capabilities of the second detection device, wherein the information is sent to the second detection device based on the capabilities of the second detection device.

In some examples, the capabilities include at least one of (1) types of sensors of the second detection device, or (2) processing power of the second detection device, and sending the information to the second detection device based on the capabilities of the second detection device includes at least one of (1) sending a portion of the information corresponding to the types of sensors of the second detection device, or (2) sending a portion of the information capable of being processed with the processing power of the second detection device.

In some examples, the information includes at least one of (1) sensor data outputted by at least one sensor of the first detection device, (2) identity data indicating a determined identity based on the sensor data, (3) characteristic data of the UAV, wherein the characteristic data includes at least one of speed, direction, range, or altitude of the UAV, or (4) secondary data, wherein the secondary data includes a timestamp at which the sensor data, identity data, or characteristic data is determined.

In various embodiments, a method for managing detection and identification of a UAV by a second detection device, which is configured to detect the UAV in a second detection area, based on information sent by a first detection device, which is configured to detect the UAV in a first detection area includes receiving, by the second detection device, the information related to the UAV from the first detection device, and determining, by the second detection device, an identity of the UAV based, at least in part, on the information.

In some examples, the method further includes receiving an ETA of the UAV for reaching the second detection area of the second detection device, determining whether any UAV has been detected at the ETA, and determining whether a detected UAV and the UAV corresponding to the ETA are the same.

In some examples, determining the identity of the UAV is based, at least in part, on the information and a trust factor corresponding to the information.

In some examples, the trust factor is based on one or more of (1) a predetermined value, (2) a measurement time interval starting when the UAV enters the first detection area of the first detection device and ending when the UAV exits the first detection area of the first detection device, (3) a distance that the UAV traveled within the first detection area of the first detection device, (4) types of sensors used by the first detection device to determine the information, (5) accuracy of at least one of the sensors used by the first detection device to determine the information, (6) a hysteretic value reflecting historic accuracies of the information outputted by the first detection device previously, (7) a time duration since data outputted by at least one of the sensors has been obtained, and (8) environmental conditions within the first detection area of the first detection device.

In some examples, the method further includes determining whether the information needs to be updated based on the trust factor by determining whether the trust factor crosses a threshold.

In various embodiments, a method for managing detection and identification of a UAV by a central server connected to a first detection device and a plurality of detection devices, the method includes receiving, by the central server, information related to the UAV from the first detection device, selecting, by the central server, a second detection device from the plurality of detection devices, and sending, by the central server, the information to the second detection device.

In some examples, the method further includes receiving data indicating at least one of position, speed, direction, or altitude of the UAV from the first detection device, and wherein selecting the second detection device the at least one neighbor detection device is based on the at least one of position, speed, direction, or altitude of the UAV.

In some examples, the method further includes determining an ETA of the UAV for reaching a detection area of the second detection device based on the at least one of position, speed, direction, or altitude of the UAV.

In some examples, the information is sent to the second detection device based on the ETA.

In some examples, the second detection device is selected based on the ETA.

In some examples, the method further includes sending, with the information, a trust factor associated with the information to the second detection device.

In some examples, the information is sent to the second detection device based on a trust factor associated with the information.

In some examples, the trust factor is based on one or more of (1) a predetermined value, (2) a measurement time interval starting when the UAV enters the first detection area of the first detection device and ending when the UAV exits the first detection area of the first detection device, (3) a distance that the UAV traveled within the first detection area of the first detection device, (4) types of sensors used by the first detection device to determine the information, (5) accuracy of at least one of the sensors used by the first detection device to determine the information, (6) a hysteretic value reflecting historic accuracies of the information outputted by the first detection device previously, (7) a time duration since data outputted by at least one of the sensors has been obtained, and (8) environmental conditions within the first detection area of the first detection device.

In some examples, the method further includes determining whether the information needs to be updated based on the trust factor by determining whether the trust factor crosses a threshold.

In some examples, the second detection device is selected based on capabilities of the second detection device.

In various examples, an apparatus for managing detection and identification of a UAV includes a central server connected to a first detection device and a plurality of detection devices, wherein the central server is configured to receive, by the central server, information related to the UAV from the first detection device, select, by the central server, a second detection device from the plurality of detection devices connected to the central server, and send, by the central server, the information to the second detection device.

In some examples, the central server is further configured to receive data indicating at least one of position, speed, direction, or altitude of the UAV from the first detection device, and wherein selecting the second detection device is based on the at least one of position, speed, direction, or altitude of the UAV.

In some examples, the central server is further configured to determine an ETA of the UAV for reaching a detection area of the second detection device based on the at least one of position, speed, direction, or altitude of the UAV.

In some examples, the information is sent to the second detection device based on the ETA.

In some examples, the second detection device is selected based on the ETA.

In some examples, the second detection device is selected based on capabilities of the second detection device.

In some examples, the central server is further configured to send, with the information, a trust factor associated with the information to the second detection device.

In some examples, the information is sent to the second detection device based on a trust factor associated with the information.

### BRIEF DESCRIPTION OF THE DRAWINGS

The accompanying drawings, which are incorporated herein and constitute part of this specification, illustrate exemplary examples of the disclosure, and together with the general description given above and the detailed description given below, serve to explain the features of the various examples.

FIG. 1 is a diagram illustrating an interaction between an Unmanned Aerial Vehicle (UAV) and an identification apparatus arranged on a structure according to various examples.

FIG. 2A is a schematic diagram illustrating an acoustic-based identification apparatus according to various examples.

FIG. 2B is a schematic diagram illustrating an acoustic-based identification apparatus according to various examples.

FIG. 2C is a schematic diagram illustrating an audio sensor array according to various examples.

FIG. 2D is a schematic diagram illustrating an audio sensor array according to various examples.

FIG. 3A is a schematic diagram illustrating a UAV suitable for identification by the identification apparatus according to various examples.

FIG. 3B is a schematic diagram illustrating a UAV suitable for identification by the identification apparatus according to various examples.

FIG. 3C is a schematic diagram illustrating a UAV suitable for identification by the identification apparatus according to various examples.

FIG. 3D is a schematic diagram illustrating a UAV suitable for identification by the identification apparatus according to various examples.

FIG. 4A is a process flow diagram illustrating a UAV identification method using the acoustic-based identification apparatus according to various examples.

FIG. 4B is a graph (frequency versus time) illustrating acoustic signatures corresponding to maneuver types of a UAV according to various examples.

FIG. 5 is a schematic diagram illustrating a fusion identification apparatus according to various examples.

FIG. 6A is a schematic diagram illustrating a visual sensor array according to various examples.

FIG. 6B is a schematic diagram illustrating a video/image-based identification apparatus according to various examples.

FIG. 7 is a process flow diagram illustrating a UAV identification method using a fusion identification apparatus according to various examples.

FIG. 8 is a process flow diagram illustrating a UAV identification method using the acoustic-based identification apparatus and the video/image-based identification apparatus according to various examples.

FIG. 9 is a diagram illustrating a collaborative UAV detection and management system for identifying UAVs according to various examples.

FIG. 10 is a diagram illustrating a deployment arrangement of a collaborative UAV detection and management system according to various examples.

FIG. 11 is a diagram illustrating a handover mechanism for handing over information related to a UAV from a first detection device to a second detection device in a collaborative UAV detection and management system according to various examples.

FIG. 12 is a process flow diagram illustrating a method for managing detection and identification of a UAV performed by a first detection device according to various examples.

FIG. 13A is a process flow diagram illustrating a method for managing detection and identification of a UAV performed by the first detection device involving selection of a second detection device to which information related to the UAV is sent according to various examples.

FIG. 13B is a process flow diagram illustrating a method for managing detection and identification of a UAV performed by the first detection device based on an Estimated Time of Arrival (ETA) according to various examples.

FIG. 13C is a process flow diagram illustrating a method for managing detection and identification of a UAV performed by a first detection device involving a trust factor according to various examples.

FIG. 13D is a process flow diagram illustrating a method for managing detection and identification of a UAV performed by a first detection device based on channel conditions according to various examples.

FIG. 13E is a process flow diagram illustrating a method for managing detection and identification of a UAV performed by a first detection device based on sensor prioritization according to various examples.

FIG. 13F is a process flow diagram illustrating a method for managing detection and identification of a UAV performed by a first detection device based on capabilities of a second detection device according to various examples.

FIG. 14 is a process flow diagram illustrating a method for managing detection and identification of a UAV performed by a second detection device according to various examples.

FIG. 15A is a process flow diagram illustrating a method for managing detection and identification of a UAV performed by a second detection device based on an ETA according to various examples.

FIG. 15B is a process flow diagram illustrating a method for managing detection and identification of a UAV performed by a second detection device involving a trust factor according to various examples.

FIG. 16A is a process flow diagram illustrating a method for managing detection and identification of a UAV performed by a central server according to various examples.

FIG. 16B is a process flow diagram illustrating a method for managing detection and identification of a UAV performed by a central server based on an ETA according to various examples.

FIG. 16C is a process flow diagram illustrating a method for managing detection and identification of a UAV performed by a central server involving a trust factor according to various examples.

FIG. 16D is a process flow diagram illustrating a method for managing detection and identification of a UAV performed by a central server based on channel conditions according to various examples.

FIG. 16E is a process flow diagram illustrating a method for managing detection and identification of a UAV performed by a central server based on capabilities of a second detection device according to various examples.

FIG. 17 is a process flow diagram illustrating a method for managing detection and identification of a UAV performed by a central server according to various examples.

### DETAILED DESCRIPTION

Various examples will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some examples for detecting and identifying an Unmanned Aerial Vehicle (UAV) implement acoustic signature deltas based on different maneuvers taken by the UAVs. An array of microphones or other audio sensors may be arranged on a building, structure, or in/around a defined area to detect audio signals from an approaching UAV. The microphone array may capture audio signals of the UAV while the UAV performs two or more maneuvers such as, but not limited to, moving in a straight line, rolling, pitching, yawing, ascending, descending, left-bank turn, right-bank turn, a combination thereof, and/or the like. The audio data captured by the array of spaced-apart audio sensors may allow detection of a distance, angle, and elevation with respect to the array (collectively, the position of the UAV) and orientation of the UAV using triangulation or trilateration. The position and the orientation may collectively be referred to as the pose of the UAV. Based on the poses of the UAV at different times, various maneuvers of the UAV may be determined. While performing the maneuvers, the acoustic signatures generated by the UAV may vary. An acoustic signature may be a distinct frequency and amplitude pattern associated with a particular maneuver.

Thus, an acoustic signature delta may be determined for the UAV. The acoustic signature delta may be any parameter or function representing the difference between two acoustic signatures associated with different maneuvers. The different maneuvers may be performed sequentially in time. The acoustic signature delta for a particular UAV may be different from those of UAVs made by different manufacturers, UAVs of different models made by the same manufacturer, a same UAV under a different condition (e.g., carrying a different payload). Generally, UAVs of different sizes, shapes, rotor types and/or numbers of rotors may produce different acoustic signature deltas. However, each UAV of the same manufacturer, model, size, shape, rotor type and/or numbers of rotors may produce the same or substantially the same acoustic signature deltas. Examples involve providing a database of acoustic signature deltas each corresponding to a known UAV identity. The UAV identity may be defined by one or more of manufacturers, models, sizes, shapes, rotor types, numbers of rotors, or other characteristics.

A processor may be configured to determine a correlation (proximity or similarity) between the acoustic signature delta and the stored acoustic signature deltas. From among the stored acoustic signature deltas, a closest match may be determined. The approaching UAV may accordingly be identified to be the UAV identity associated with the closest match.

Further examples involve providing an array of spaced visual sensors (e.g., video cameras, infrared cameras, or the like) to capture video streams (or images) of the approaching UAV. A database may include motion information relating to the motion that different UAVs make when performing one or more specific maneuvers such as, but not limited to, moving in a straight line, rolling, pitching, yawing, ascending, descending, left bank turn, right bank turn, a combination thereof, and/or the like. The motion (as defined by at least one motion vector, angle, amount of pitch, yaw, roll, or the like) of a UAV corresponding to a particular maneuver may differ among different types of UAVs, but can be the same or substantially the same for UAVs of the same type when performing the same maneuver. The video data may define the poses of the UAV, thus allowing the processor to determine the maneuver of the UAVs based on the defined poses. The poses and the maneuvers determined using the video data may be associated with audio data (e.g., the acoustic signatures) through timestamps.

In such examples, the processor may first analyze the motion information (e.g., the motion vectors of the identified moving object in the video stream) to determine whether the identified object corresponds to an object other than a UAV (e.g., to determine whether the object is an avian animal). If the processor determines that the identified object is indeed a UAV, the processor may then proceed to compare the motion information (e.g., the motion vectors) of the approaching UAV with stored motion information (stored motion vectors) to determine a correlation. The UAV identity associated with the stored motion information that best correlates with the motion information of the approaching UAV may be selected as the identity for the approaching UAV.

A fusion identification apparatus combining the audio and video data detection methods described herein may greatly increase the confidence level of proper identification. The identification based on audio signals and the identification based on the video signals may be time-aligned using timestamps. The audio signals and the video signals corresponding to the same timestamp may be used to determine the identity of the UAV. For example, the identity of the approaching UAV may be determined as the result of a weighted correlation based on the acoustic signature delta and the motion vectors. The fusion identification apparatus may likewise correlate additional data to increase the confidence level. The additional data may include radar data, intercepted wireless communication signals, infrared data, or the like. Accordingly, the approaching UAV may be distinguished from other UAVs and/or from other non-UAV flying objects. In further or alternative examples, other sensors and/or other devices that provide information about the approaching UAV may be implemented in the fusion identification apparatus to increase the confidence level of proper identification of the UAV.

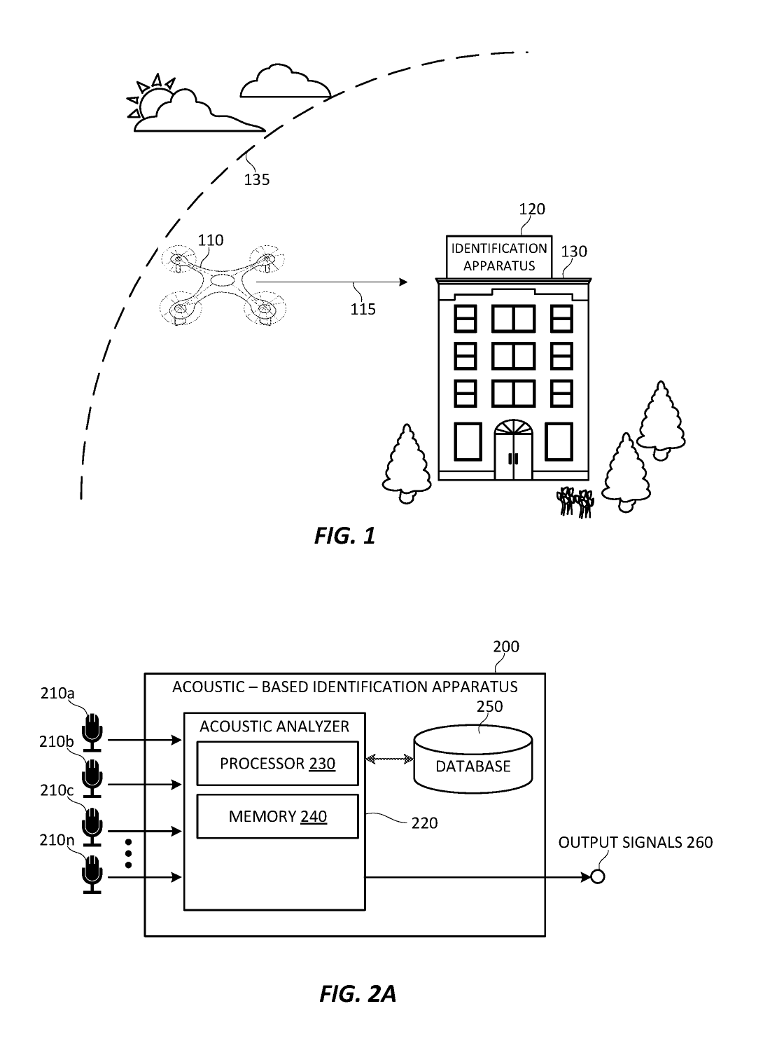

FIG. 1 is a diagram illustrating an interaction between a UAV 110 and an identification apparatus 120 arranged on a structure 130 according to various examples. Referring to FIG. 1, the structure 130 may be any suitable building, wall, or geographical location having the identification apparatus 120 installed for UAV detection and identification purposes. The structure 130 may have a height (in case of a building or hill), or the structure 130 may be leveled (in case of a parking lot or sports field).

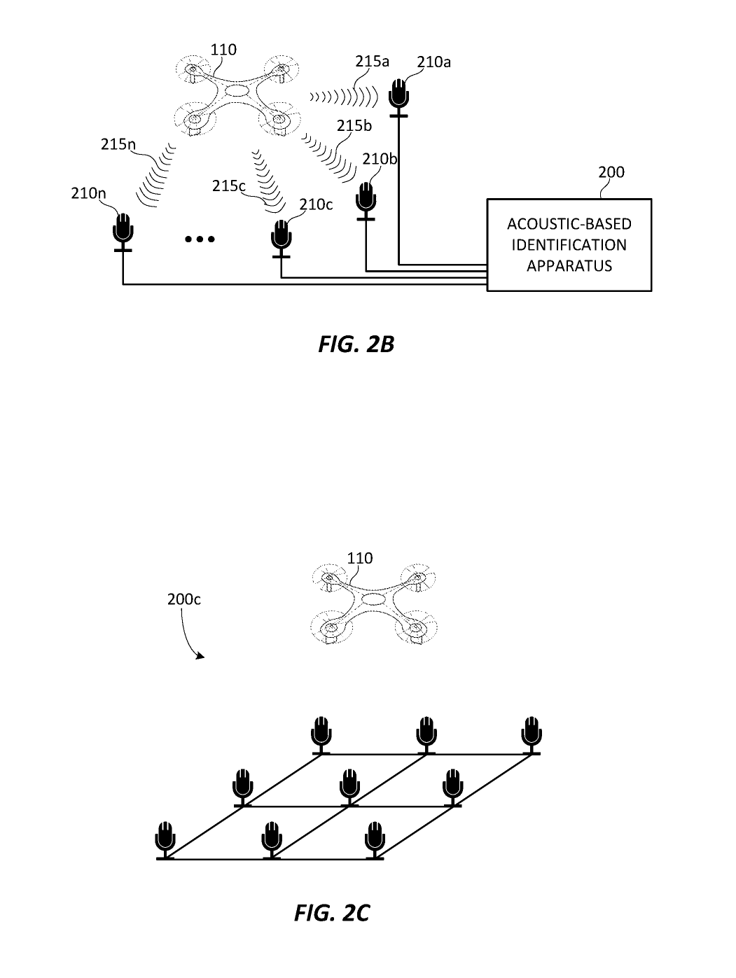

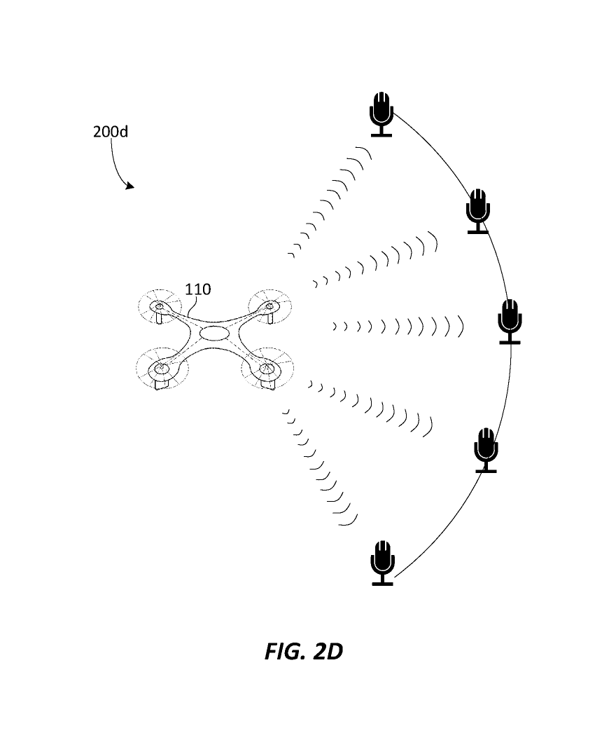

The identification apparatus 120 may be provided on any part of the structure 130 or adjacent to the structure 130. In further examples, a plurality of identification apparatuses such as, but not limited to, the identification apparatus 120 may be provided on or around the structure 130, or throughout an area associated with the structure 130. Illustrating with a non-limiting example, when the structure 130 is a building, the identification apparatus 120 (particularly audio sensors 210a-210n of FIG. 2A) may be arranged on a roof, exterior wall, balcony, window, or door of the structure 130. In additional non-limiting examples, the identification apparatus 120 may be provided on the ground or on another structure (similar to the structure 130) proximal to (within 5 m, 10 m, 20 m, or the like) the structure 130.

The UAV 110 may be moving along a forward direction 115 toward or in the general direction of the structure 130 and/or the identification apparatus 120. The UAV 110 may be within an identification boundary 135. The identification boundary 135 may be an effective boundary within which the identification apparatus 120 can appropriately identify the approaching UAV 110. For example, the identification boundary 135 may correspond to the effective detection distance of various sensors used in the identification apparatus 120 as described herein.

FIG. 2A is a schematic diagram illustrating an acoustic-based identification apparatus 200 according to various examples. Referring to FIGS. 1-2A, the acoustic-based identification apparatus 200 may be an example of the identification apparatus 120 in some examples. In various examples, the acoustic-based identification apparatus 200 may be a part of the identification apparatus 120, which may include additional elements using different types of sensors than those of the acoustic-based identification apparatus 200. The acoustic-based identification apparatus 200 may include at least a plurality of audio sensors 210a-210n, an acoustic analyzer 220, and a database 250. The components of the identification apparatus 120 other than the audio sensors 210a-210n may be provided at one or more locations other than the location of the audio sensors 210a-210n.

The audio sensors 210a-210n may be configured to capture audio signals from the approaching UAV 110 (e.g., within the identification boundary 135). Particularly, the rotor acoustic noise, among other types of audio signals generated by the UAV 110 may be captured by the audio sensors 210a-210n. In some examples, one or more of the audio sensors 210a-210n may be integrated with the rest of the acoustic-based identification apparatus 200 or otherwise housed inside of a housing of the acoustic-based identification apparatus 200. In other examples, one or more of the audio sensors 210a-210n may be auxiliary to and not integrated with the acoustic-based identification apparatus 200, but may be operatively coupled to the acoustic-based identification apparatus 200 through a wired or wireless connection. For instance, one of more of the audio-sensors 210a-210n may be arranged at designated locations, for example as an array (e.g., 200c, 200d in FIGS. 2C-2D) within the identification boundary 135.

In some examples, one or more of the audio sensors 210a-210n may be omnidirectional microphones configured to capture sound from any direction. In some examples, one or more of the audio sensors 210a-210n may be a unidirectional microphone that may be configured to capture sound from a predefined direction. In some examples, one or more of the audio sensors 210a-21On may be a microphone of any other polarization pattern. The audio sensors 210a-210n may be arranged as a microphone array in the manner described.

The acoustic analyzer 220 may be coupled to the audio sensors 210a-210n and configured to analyze audio signals corresponding to acoustic sound generated by the UAV 110 and captured by the audio sensors 210a-210n. Analyzing the audio signals may refer to processing the audio signals to determine an identity or characteristics of the UAV 110. The data related to the identity of the UAV 110 may be outputted as output signals 260. The identity or type of the UAV 110 may refer to one or more of manufacturer, model, shape, size, number of rotors, or other suitable characteristics associated with the UAV 110. Identifying the UAV 110 may refer to matching the UAV 110 with at least one of multiple different types of UAVs based on the acoustic signature delta. In further examples described herein, additional types of data such as, but not limited to, video/image data, infrared/thermal data, radar data, intercepted wireless control communication data, and/or the like may also be used for identifying the UAV.

The acoustic analyzer 220 may include at least a processor 230 and a memory 240 configured for analyzing the audio signals. According to some examples, the memory 240 may be a non-transitory processor-readable storage medium that stores processor-executable instructions. The memory 240 may include any suitable internal or external device for storing software and data. Examples of the memory 240 may include, but are not limited to, Random Access Memory (RAM), Read-Only Memory (ROM), floppy disks, hard disks, dongles, or other Recomp Sensor Board (RSB) connected memory devices, or the like. The memory 240 may store an operating system (OS), user application software, and/or executable instructions. The memory 240 may also store application data, such as, but not limited to, an array data structure.

According to some examples, the processor 230 may be a general-purpose processor. The processor 230 may include any suitable data processing device, such as, but not limited to, a microprocessor, Central Processor Unit (CPU), or custom hardware. In the alternative, the processor 230 may be any suitable electronic processor, controller, microcontroller, or state machine. The processor 230 may also be implemented as a combination of computing devices (e.g., a combination of a digital signal processor (DSP) and a microprocessor, a plurality of microprocessors, at least one microprocessor in conjunction with a DSP core, or any other suitable configuration).

The acoustic analyzer 220 may be coupled to the database 250 to access data related to the acoustic signature deltas of various UAV identities. The database 250 may be any non-transitory storage medium (such as, but not limited to, the memory 240) storing acoustic data for known acoustic signature deltas generated by the various known UAVs.

FIG. 2B is a schematic diagram illustrating an example audio sensor configuration of the acoustic-based identification apparatus 200 (FIG. 2A) according to various examples. Referring to FIGS. 1-2B, the acoustic-based identification apparatus 200 may include or be coupled to the audio sensors 210a-210n, which may be arranged in suitable configurations to capture acoustic sound (audio signals 215a-215n) generated by the UAV 110. In some examples, the audio sensors 210a-210n may be spaced apart and positioned in suitable locations in various audio sensor configurations or arrays. Using the audio sensor array to capture the audio signals 215a-215n may allow accurate detection of the audio signals 215a-215n corresponding to the acoustic sound generated by the UAV 110. The audio sensor array, which may include two or more audio sensors, may also be capable of determining a pose (defined by position and orientation of the UAV 110) of the UAV 110 through triangulation/trilateration.

FIG. 2C is a schematic diagram illustrating an audio sensor array 200c according to various examples. Referring to FIGS. 1-2C, the audio sensor array 200c may be an arrangement of the audio sensors 210a-210n according to various examples. The audio sensor array 200c may include audio sensors (e.g., the audio sensors 210a-210n) arranged in a planar configuration (planar array) to capture acoustic sound generated by the UAV 110. The audio sensor array 200c may be a plane parallel or nonparallel to a ground level. At least one additional planar array such as the audio sensor array 200c may be added (in a same or different plane) in further examples.

FIG. 2D is a schematic diagram illustrating an audio sensor array 200d according to various examples. Referring to FIGS. 1-2D, the audio sensor array 200d may correspond to an arrangement of the audio sensors 210a-210n according to various examples. The audio sensor array 200d may include audio sensors (e.g., the audio sensors 210a-210n) arranged in a half-dome configuration (or other-shaped configuration) to capture acoustic sounds generated by the UAV 110. The audio sensor array 200d may form a half-dome in a plane parallel or nonparallel to the ground level. At least one additional half-dome such as the audio sensor array 200d may be added (in a same or different plane) in further examples.

While the planar audio sensor array 200c and the half-dome audio sensor array 200d are illustrated herein, additional or alternative audio sensor array configuration such as, but not limited to, a Soundfield array, may be implemented.

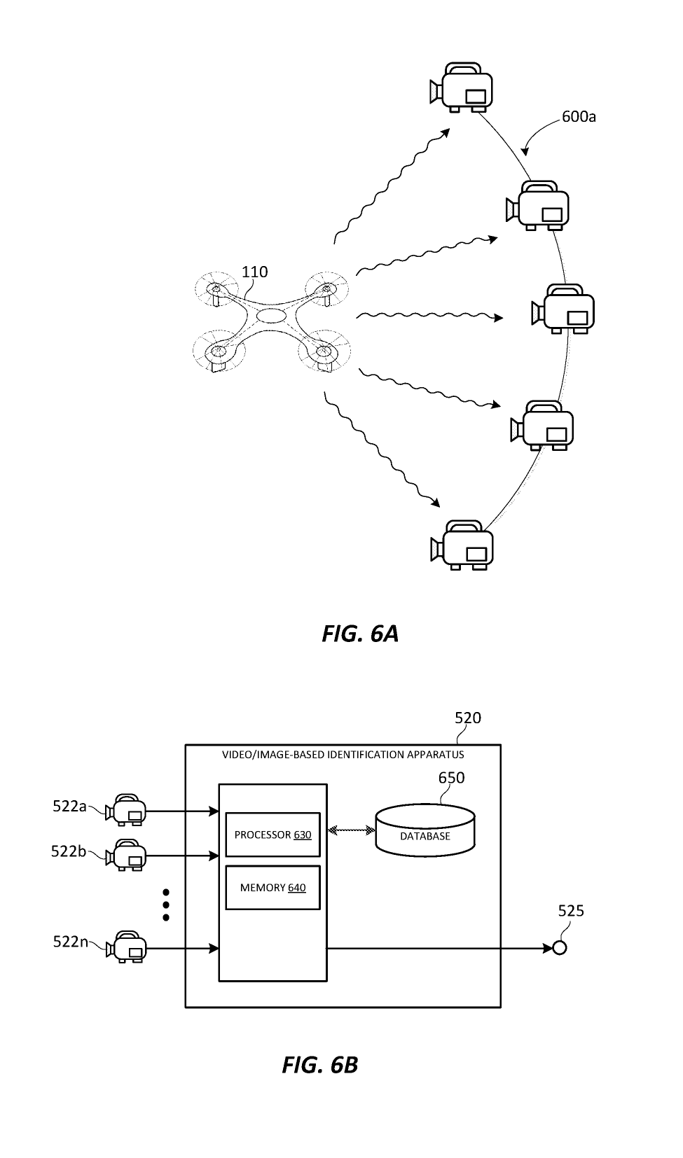

In some examples the identification apparatus 120 may be a video/image-based identification apparatus (such as, but not limited to, a video/image-based identification apparatus (e.g., 520 of FIG. 6B). The video/image-based identification apparatus may include at least a plurality of visual sensors 522a-522n, processor 630, memory 640, database 650, and/or the like (e.g., as shown in FIG. 6B). The visual sensors 522a-522n (e.g., FIG. 6B) may be arranged in a visual sensor array (such as, but not limited to, a visual sensor array 600a in FIG. 6A). In some examples, the acoustic-based identification apparatus 200 may be implemented in conjunction with the video/image-based identification apparatus in the manner described.

Various examples of the UAV 110 may be detected using the identification apparatus 120. A flight power source for the UAV 110 may include one or more propellers that generate a lifting force sufficient to lift the UAV 110 (including the UAV structure, motors, rotors, electronics, and power source) and any loads attached thereto. The flight power source may be powered by an electrical power source such as a battery. Alternatively, the flight power source may be a fuel-controlled motor, such as one or more internal combustion motors. While the present disclosure is directed to examples of electric motor controlled UAVs, the concepts disclosed herein may be applied equally to UAVs powered by virtually any power source. Flight power sources may be vertical or horizontally mounted depending on the flight mode of the UAV 110.

A UAV configuration in various examples is a “quad-copter” configuration. In an example quad-copter configuration, typically four (or more or fewer in other examples) horizontally configured rotary lift propellers and motors are fixed to a frame. In other examples, UAVs with different numbers, sizes, and shapes of rotors (propellers) may likewise be detectable. Distinctions related to manufacturer, model, shape, size, number of rotors, or the like may substantially contribute to the acoustic sound generated by the UAV 110. Other characteristics of the UAV 110 may also contribute to the acoustic sound generated by the UAV 110. The frame may include a frame structure with landing skids that supports the propulsion motors, power source (e.g., battery), payload securing mechanism, or other structures or devices. A payload may be attached in a central area underneath the frame structure platform of the UAV 110, such as in an area enclosed by the frame structure and skids beneath the flight power sources or propulsion units. The UAV 110 may fly in any unobstructed horizontal and vertical direction or may hover in place.

The UAV 110 may be configured with one or more processing and communication devices that enable the device to navigate, such as by controlling the flight motors to achieve flight directionality and to receive position information and information from other system components including beacons, servers, access points, and so on. The position information may be associated with the current position, way points, flight paths, avoidance paths, altitudes, destination locations, locations of charging stations, etc.

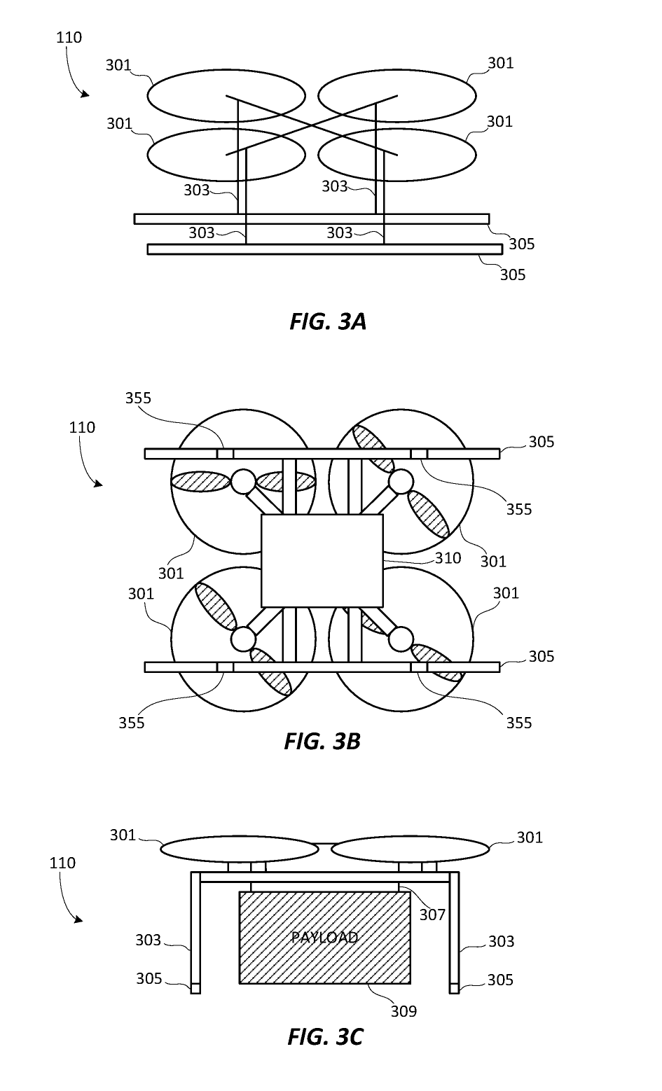

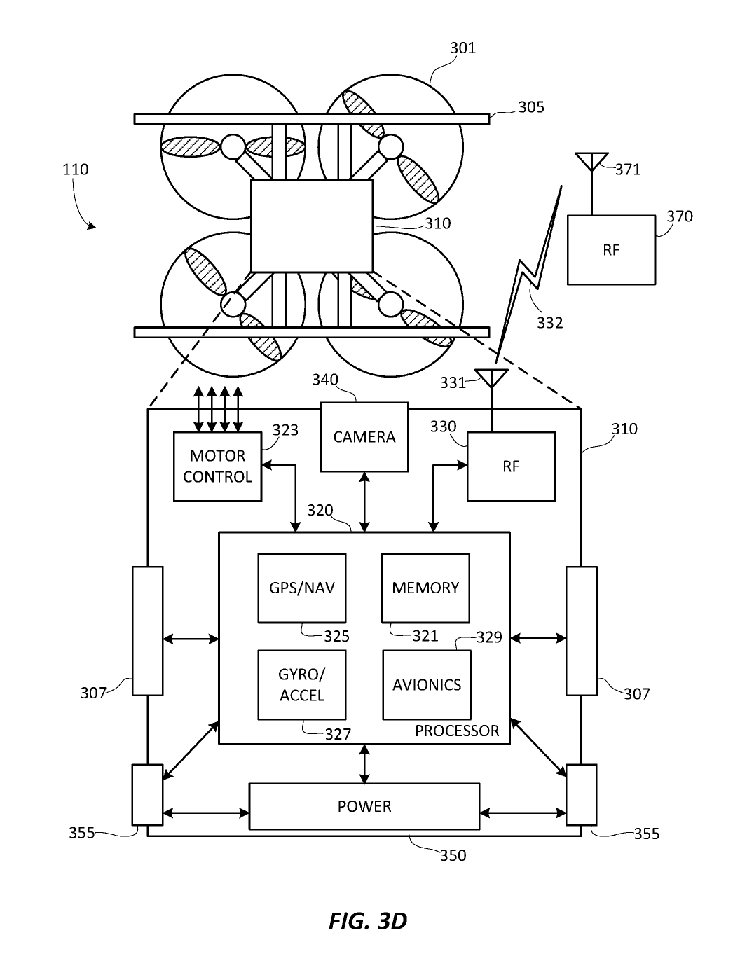

In some examples (e.g., FIGS. 3A-3C), the UAV 110 may include a plurality of rotors 301, a frame 303, and landing skids 305. In the illustrated examples, the UAV 110 has four rotors 301. However, in other examples, the UAV 110 may have more or fewer than four rotors 301. The frame 303 may provide structural support for the motors associated with the rotors 301, and for the landing skids 305. The frame 303 may be sufficiently strong to support the maximum load weight for the combination of the components of the UAV 110 and, in some cases, a payload 309 (shown in FIG. 2C). For ease of description and illustration, some detailed aspects of the UAV 110 are omitted such as wiring, frame structure interconnects or other features that would be known to one of skill in the art. For example, while the UAV 110 is shown and described as having a frame 303 having a plurality of support members or frame structures, the UAV 110 may be constructed with a unitary frame structure for example, but not limited to, a molded frame in which support for multiple rotors is provided by a single, unitary, molded structure.

In some examples, the landing skids 305 of the UAV 110 may be provided with landing sensors 355. The landing sensors 355 may be optical sensors, radio sensors, camera sensors, or other sensors that sense a landing state of the UAV 110. Alternatively or additionally, the landing sensors 355 may be contact or pressure sensors that may provide a signal indicating when the UAV 110 has made contact with a surface. In some examples, the landing sensors 355 may be adapted to provide the additional ability to charge a battery when the UAV 110 is positioned on a suitable landing pad, such as through charging connectors. In some examples, the landing sensors 355 may provide additional connections with a landing pad (not shown), such as wired communication or control connections. The UAV 110 may further include a control unit 310 that may house various circuits and devices used to power and control the operation of the UAV 110, including motors for powering rotors 301, a battery (e.g., a power module 350), a communication module (e.g., a radio module 330), and so on.

In various examples, the UAV 110 may be equipped with a payload-securing unit 307. The payload-securing unit 307 may include an actuator motor that drives a gripping and release mechanism and related controls that are responsive to a control unit to grip and release the payload 309 in response to communications from the control unit.

An example of a control unit 310 for the UAV 110 suitable for use with the various examples is illustrated in FIG. 3D. With reference to FIGS. 1-3D, the control unit 310 may include a processor 320, the radio module 330, and the power module 350. The processor 320 may include or be coupled to a memory unit 321 and a navigation unit 325. The processor 320 may be configured with processor-executable instructions to control flight and other operations the UAV 110, including operations of the various examples. The processor 320 may be coupled to the payload securing unit 307 and the landing sensors 355. The processor 320 may be powered from a power module 350, such as a battery. The processor 320 may be configured with processor-executable instructions to control the charging of the power module 350, such as by executing a charging control algorithm using a charge control circuit. Alternatively or additionally, the power module 350 may be configured to manage its own charging. The processor 320 may be coupled to a motor control unit 323 that is configured to manage the motors that drive the rotors 301.

Through control of the individual motors of the rotors 301, the UAV 110 may be controlled in flight as the UAV 110 progresses toward a destination. In some examples, the navigation unit 325 may send data to the processor 320 and use such data to determine the present position and orientation of the UAV 110, as well as the appropriate course towards the destination. In some examples, the navigation unit 325 may include a (Global Navigation Satellite System) GNSS receiver system (e.g., one or more (Global Positioning System) GPS receivers) enabling the UAV 110 to navigate using GNSS signals, and the radio navigation receivers for receiving navigation beacon or other signals from radio nodes, such as navigation beacons (e.g., Very High Frequency (VHF) Omni Directional Radio Range (VOR) beacons), Wi-Fi access points, cellular network sites, radio station, etc. The processor 320 and/or the navigation unit 325 may be configured to communicate with a server (e.g., wireless communication devices 370) through a wireless connection (e.g., a wireless communication link 332) to receive data useful in navigation as well as to provide real-time position reports.

An avionics module 329 coupled to the processor 320 and/or the navigation unit 325 may be configured to provide flight control-related information such as altitude, attitude, airspeed, heading and similar information that the navigation unit 325 may use for navigation purposes, such as dead reckoning between GNSS position updates. The avionics module 329 may include or receive data from a gyro/accelerometer unit 327 that may provide data regarding the orientation and accelerations of the UAV 110 that may be used in navigation calculations.

The radio module 330 may be configured to receive navigation signals, such as beacon signals from restricted areas, signals from aviation navigation facilities, etc., and provide such signals to the processor 320 and/or the navigation unit 325 to assist in navigation of the UAV 110. In some examples, the navigation unit 325 may use signals received from recognizable Radio Frequency (RF) emitters (e.g., AM/FM radio stations, Wi-Fi access points, cellular network base stations, etc.) on the ground. The locations, unique identifiers, single strengths, frequencies, and other characteristic information of such RF emitters may be stored in a database and used to determine position (e.g., via triangulation and/or trilateration) when RF signals are received by the radio module 330. Such a database of RF emitters may be stored in the memory unit 321 of the UAV 110, in a ground-based server (e.g., the wireless communication devices 370) in communication with the processor 320 via a wireless communication link (e.g., the wireless communication link 332), or in a combination of the memory unit 321 and a ground-based server. Navigating using information about RF emitters may use any of a number of conventional methods. For example, upon receiving an RF signal via the radio module 330, the processor 320 may obtain the RF signal's unique identifier (e.g., a Service Sector Identification (SSID), a Media Access Control (MAC) address associated with the UAV 110, radio station call sign, cell ID, etc.), and use that information to obtain the ground coordinates and signal strength of the detected RF emitter from the database of RF emitter characteristics. If the database is stored in the onboard memory unit 321, the processor 320 may use the emitter identifier information to perform a table look up in the database. Alternatively or in addition, the processor 320 may use the radio module 330 to transmit the detected RF emitter identifier to a Location Information Service (LIS) server, which may return a location of the RF emitter obtained an RF emitter location database. Using the RF emitters coordinates and optionally the signal strength characteristics, the processor 320 (or the navigation unit 325) may estimate the location of the UAV 110 relative to those coordinates. Using locations of three or more RF emitters detected by the radio module 330, the processor may determine a more precise location via trilateration. Estimates of location based on received ground-based RF emitters may be combined with position information from a GNSS receiver to provide more precise and reliable location estimates than achievable with either method alone.

The processor 320 may use the radio module 330 to conduct wireless communications with a variety of wireless communication devices 370, such as beacon, a server, smartphone, tablet, or other device with which the UAV 110 may be in communication. The bi-directional wireless communication link 332 may be established between transmit/receive antenna 331 of the radio module 330 and transmit/receive antenna 371 of the wireless communication device 370. For example, the wireless communication device 370 may be a beacon that controls access to a restricted area as described herein. In an example, the wireless communication device 370 may be a cellular network base station or cell tower. The radio module 330 may be configured to support multiple connections with different wireless communication devices 370 having different radio access technologies. In some examples, the wireless communication device 370 may be connected to a server or may provide access to the server. In an example, the wireless communication device 370 may be a server of a UAV operator, a third party service (e.g., package delivery, billing, etc.), or an operator of a restricted area. The UAV 110 may communicate with the server through an intermediate communication link such as one or more network nodes or other communication devices. The signals received from or sent to the wireless communication device 370, radio nodes, Wi-Fi access points, cellular network sites, radio station, server, and/or the like may be collectively referred to as wireless communication signals.

In some examples, the radio module 330 may be configured to switch between a wireless wide area network, wireless local area network, or wireless personal area network connection depending on the location and altitude of the UAV 110. For example, while in flight at an altitude designated for UAV traffic, the radio module 330 may communicate with a cellular infrastructure in order to maintain communications with a server (e.g., 370). An example of a flight altitude for the UAV 110 may be at around 400 feet or less, such as may be designated by a government authority (e.g., FAA) for UAV flight traffic. At this altitude, it may be difficult to establish communication with some of the wireless communication devices 370 using short-range radio communication links (e.g., Wi-Fi). Therefore, communications with other wireless communication devices 370 may be established using cellular telephone networks while the UAV 110 is at flight altitude. Communication between the radio module 330 and the wireless communication device 370 may transition to a short-range communication link (e.g., Wi-Fi or Bluetooth) when the UAV 110 moves closer to the wireless communication device 370.

The wireless communication device 370 may also be a server associated with the operator of the UAV 110, which communicates with the UAV 110 through a local access node or through a data connection maintained through a cellular connection. While the various components of the control unit 310 are illustrated in FIG. 3D as separate components, some or all of the components (e.g., the processor 320, the motor control unit 323, the radio module 330, and other units) may be integrated together in a single device or module, such as a system-on-chip module.

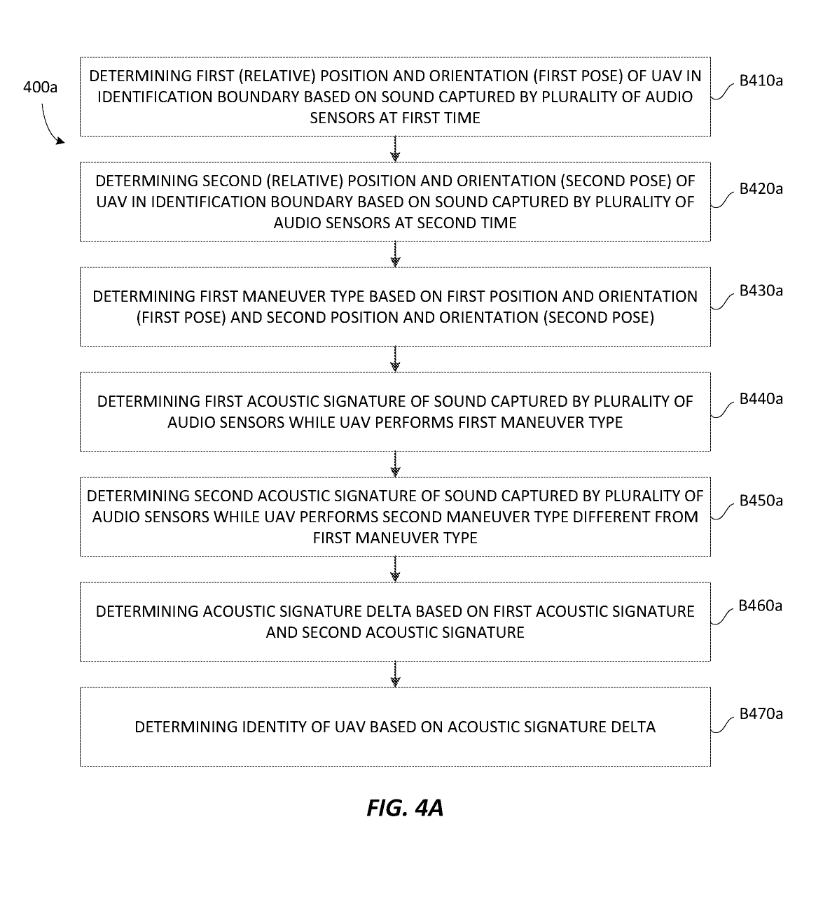

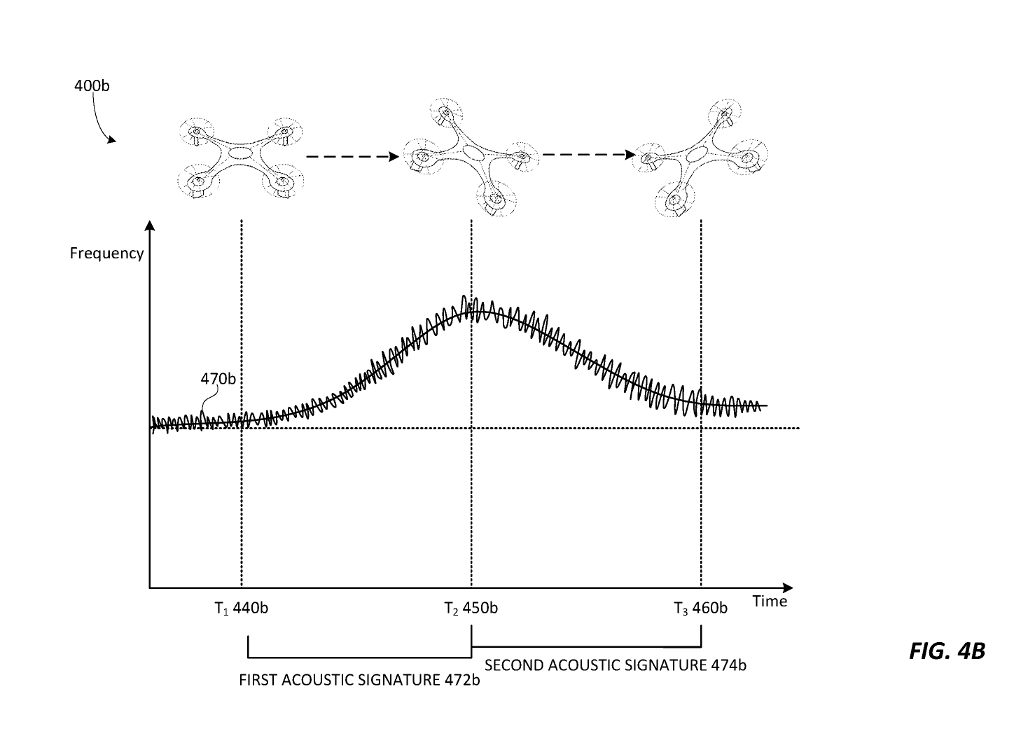

FIG. 4A is a process flow diagram illustrating a UAV identification method 400a using the acoustic-based identification apparatus 200 (e.g., FIG. 2A) according to various examples. Referring to FIGS. 1-4A, in some examples, at block B410a, the processor 230 may determine a first relative position and orientation (i.e., a first pose) of the UAV 110 in the identification boundary 135 based on sound captured by the plurality of audio sensors 210a-210n at a first time. For example, the plurality of audio sensors 210a-210n may use triangulation or trilateration to determine the position and orientation of the UAV 110 at any given moment in time (e.g., the first time) while the UAV 110 is within the identification boundary 135. In some examples, the first time may correspond to a time at which the plurality of audio sensors 210a-210n first detects any sound from the UAV 110 (i.e., when the UAV 110 first enters the identification boundary 135). In some examples, the first time may correspond to a time at which the signal-to-noise ratio for the sound associated with the UAV 110 is above a certain threshold, indicating the first pose can be determined with an acceptable accuracy.

In some examples, at block B420a, the processor 230 may determine a second relative position and orientation (i.e., a second pose) of the UAV 110 in the identification boundary 135 based on sound captured by the plurality of audio sensors 210a-210n at a second time. The second time may be later than the first time. In some examples, the second time may equal to the first time plus a certain time interval (e.g., 2 s, 5 s, 6 s, 10 s, 15 s, or the like). The processor 230 may automatically trigger the determination of the second pose at the second time. Similarly, the plurality of audio sensors 210a-210n may use triangulation or trilateration to determine the position and orientation of the UAV 110 at the second time while the UAV 110 is within the identification boundary 135.

In some examples, at block B430a, the processor 230 may determine a first maneuver type based on the first pose and the second pose. For example, the first maneuver type may be one or more of moving in a straight line, banking left, banking right, ascending, descending, rolling, pitching, yawing, a combination thereof, and the like. Illustrating with a non-limiting example, the first maneuver type may be flying in a straight line from east to west when the first pose is the UAV 110 being at a first position oriented to face west, and the second pose is the UAV 110 being at a second position directly west of the first position. In other words, the first maneuver type may be determined based on one or more of a starting position/orientation (i.e., the first relative position/orientation or pose of the UAV 110) and a next position/orientation (i.e., the second relative position/orientation or pose of the UAV 110).

In some examples, at block B440a, the processor 230 may determine a first acoustic signature of the sound captured by the plurality of audio sensors 210a-210n while the UAV 110 performs the first maneuver type, for example, between the first and second time (or sometime after the second time). The first acoustic signature may refer to one or more of frequency or amplitude of the sound signals captured while the UAV 110 performs the first maneuver type, such as between the first time and the second time or after the second time (the third time).

In some examples, at block B450a, the processor 230 may determine a second acoustic signature of sound capture by the plurality of audio sensors 210a-21On while the UAV 110 performs a second maneuver type different from the first maneuver type. The second acoustic signature may be determined in a manner similar to described with respect to the first acoustic signature in blocks B410a-B440a. The second acoustic signature may refer to one or more of frequency or amplitude of the sound signals captured while the UAV 110 performs the second maneuver type, such as after the second time.

For example, the processor 230 may determine a third pose of the UAV 110 in the identification boundary 135 based on sound captured by the plurality of audio sensors 210a-210n at a third time. The third time may be subsequent to both the first time and the second time in some examples. In other examples, the third time is the second time (i.e., the second maneuver type directly follow the first maneuver type without any or minimal time gap in between). The processor 230 may then determine a fourth pose of the UAV 110 in the identification boundary 135 based on sound captured by the plurality of audio sensors 210a-210n at a fourth time. The fourth time may be subsequent to the first time, second time, and the third time. Similarly, the fourth time may equal to the third time plus a certain time interval (e.g., 2 s, 5 s, 6 s, 10 s, 15 s, or the like). The processor 230 may then determine the second maneuver type based on the third pose and the fourth pose similar to described with respect to the first maneuver type. In some examples, if the first maneuver type and the second maneuver type are determined to be the same or having a difference that is below a certain threshold, then the processor 230 may re-determine the second maneuver type at a subsequent time interval after the fourth time until the second maneuver type is different from the first maneuver type. Illustrating with a non-limiting example, when the UAV 110 continues to fly in a straight line from east to west, the processor 230 may re-determine the second maneuver type between a fifth time and a sixth time (both subsequent to the fourth time) as a response until the second maneuver type is different from the first maneuver type (e.g., banking 45 degrees to the left). Next, the processor 230 may determine the second acoustic signature corresponding to the second maneuver type in a manner similar to described with respect to the first acoustic signature.

In some examples, at block B460a, the processor 230 may determine an acoustic signature delta based on the first acoustic signature and the second acoustic signature. In some examples, the acoustic signature delta may include a frequency delta (difference between a first frequency associated with the first acoustic signature and a second frequency associated with the second acoustic signature), an amplitude delta (difference between a first amplitude associated with the first acoustic signature and a second amplitude associated with the second acoustic signature), or a combination thereof. In addition or alternatively, other suitable types of acoustic signature delta representing one or more differences between the first acoustic signature and the second acoustic signature may be used.

In some examples, at block B470a, the processor 230 may determine the identity of the UAV 110 based on the acoustic signature delta. In particular, the processor 230 may compare the acoustic signature delta with known and stored acoustic signature deltas in a database (the database 250). Each of the known and stored acoustic signature deltas may correspond to one of a plurality of UAV identities. In other words, each stored acoustic signature delta may correspond to a particular type of UAV. The processor 230 may select one of the plurality of UAV identities based on a correlated closest (best) match between the acoustic signature delta and the acoustic signature deltas in the database 250. Specifically, the closest match for the UAV identity may be one that best correlates with the acoustic signature delta obtained at block B460a. In other examples, the processor 230 may select a set of the plurality of UAV identities based on correlated closest matches, for instance.

FIG. 4B is a graph 400b illustrating audio signals 470b corresponding to the sound of the UAV 110 (FIG. 1) captured by the plurality of audio sensors 210a-210n (FIG. 2A) according to various examples. Referring to FIGS. 1-4B, when the UAV 110 performs maneuvers, the UAV 110 may generate sound corresponding to the audio signals 470b. The audio signals 470b may include a first acoustic signature 472b and a second acoustic signature 474b. The first acoustic signature 472b may be prior in time than the second acoustic signature 474b.

The UAV 110 may perform a first maneuver (e.g., banking left) starting from timestamp T₁ 440b (the first time) and ending at timestamp T₂ 450b (the second time). The first pose may be determined at timestamp T₁ 440b. The second pose may be determined at timestamp T₂ 450b. The first maneuver type may accordingly be determined based on block B430a. The time interval between T₁ 440b and T₂ 450b may define the first acoustic signature 472b associated with the first maneuver type. That is, the audio signatures of the audio signals 470b between T₁ 440b and T₂ 450b may be the first acoustic signature.

The UAV 110 may perform a second maneuver (e.g., banking right) starting from timestamp T₂ 450b (the third time, which is the same as the second time in this non-limiting example) and ending at timestamp T₃ 460b (the fourth time). The third pose may be determined at timestamp T₂ 450b. The fourth pose may be determined at timestamp T₃ 460b. The second maneuver type may accordingly be determined based on block B450a. The time interval between T₂ 450b and T₃ 460b may define the second acoustic signature 474b associated with the second maneuver type. That is, the audio signatures of the audio signals 470b between T₂ 450b and T₃ 460b may be the second acoustic signature.

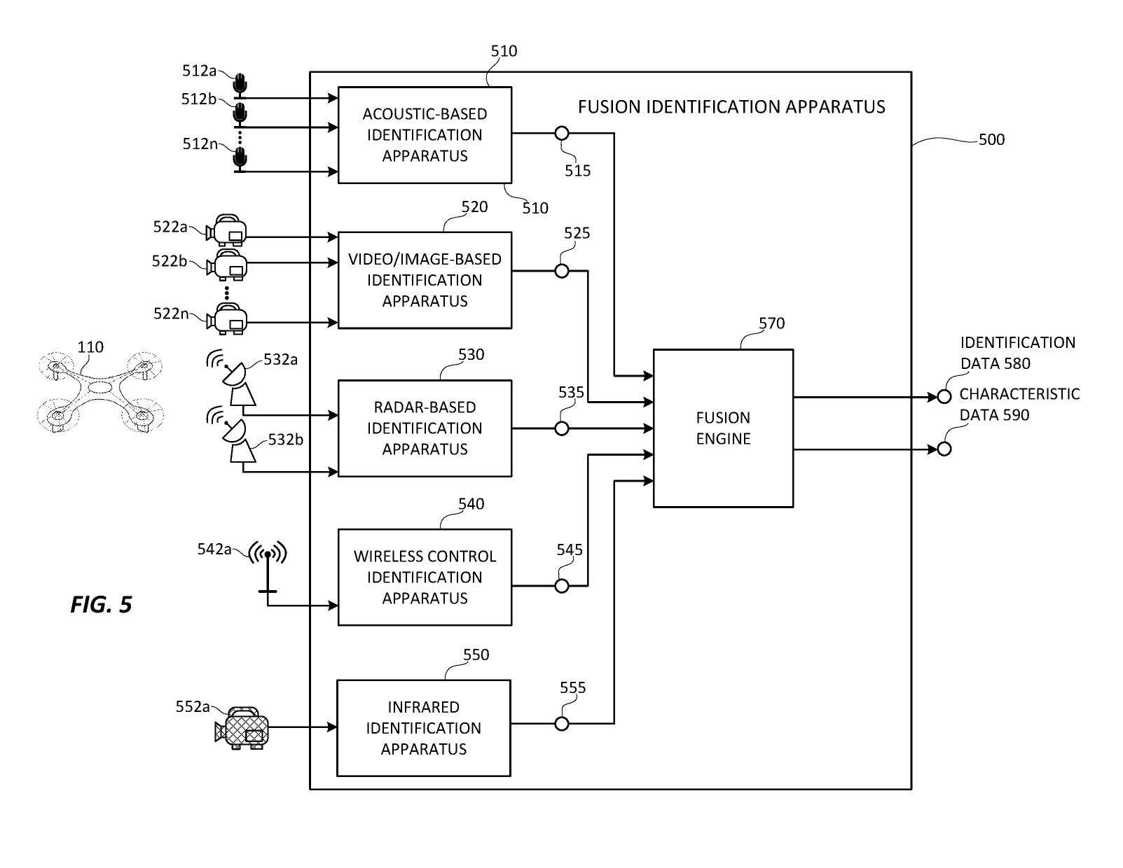

FIG. 5 is a schematic diagram illustrating a fusion identification apparatus 500 according to various examples. Referring to FIGS. 1-5, the fusion identification apparatus 500 may be the identification apparatus 120 in some examples. Particularly, the fusion identification apparatus 500 may include an acoustic-based identification apparatus 510 that corresponds to the acoustic-based identification apparatus 200. The acoustic-based identification apparatus 510 may include audio sensors 512a-512n, each of which may correspond to a respective one of the audio sensors 210a-210n. In some examples, the acoustic-based identification apparatus 510 may output first identity data 515 including the output signals 260 (i.e., the determined identity of the UAV 110 based on the acoustic-based processes as described). In some examples, the first identity data 515 may include a ranked list of “best estimates” based on the processes of the acoustic-based identification apparatus 510. For example, the first identity data 515 may include multiple potential identities for the UAV 110 and correlation coefficients (or other suitable indicators of confidence level) associated with each of these potential identities.

In some examples, the fusion identification apparatus 500 may additionally include a video/image-based identification apparatus 520 for determining the identity and/or characteristics of the UAV 110. The video/image-based identification apparatus 520 may include or be coupled at least one visual sensor (e.g., visual sensors 522a-522n). Each of the visual sensors 522a-522n may be an image or video-capturing device (e.g., a camera). In particular examples, one or more of the visual sensors 522a-522n may have a wide-angle lens.

The video/image-based identification apparatus 520 may analyze visual data (e.g., video streams) captured by the visual sensors 522a-522n to determine the identity (or a partial identity) and/or at least some of the characteristics of the UAV 110. For example, UAVs with different manufacturers, models, shapes, sizes, numbers of rotors, or other suitable characteristics may have different visual distinctions (e.g., have different contours in the visual data). Furthermore, the motion vectors corresponding to a given maneuver may also be different depending on the UAV characteristics. The video/image-based identification apparatus 520 may output second identity data 525 including at least one potential identity (or best estimated identity) of the UAV 110 and/or at least some characteristics of the UAV 110. In further examples, the second identity data 525 may include a ranked list of “best estimates” based on the processes of the video/image-based identification apparatus 520. For example, the identity data 525 may include multiple potential identities for the UAV 110 and correlation coefficients (or other suitable indicators of confidence level) associated with each of these potential identities.

In various examples, the fusion identification apparatus 500 may additionally or alternatively (instead of one of more of the acoustic-based identification apparatus 510 and the video/image-based identification apparatus) include other identification apparatuses for identifying at least some information or characters of the UAV 100.

In some examples, the fusion identification apparatus 500 may additionally or alternatively include a radar-based identification apparatus 530 for determining the identity and/or at least some characteristics of the UAV 110. The radar-based identification apparatus 530 may include or be coupled to at least one radar (e.g., first radar 532a, second radar 532b, and/or the like). Each of the at least one radar may be a Continuous Wave (CW) radar. CW radars may include, for example, Doppler radars and Frequency Modulated (FM) radars. Doppler radars can detect existence and velocity of the UAV 110. FM radars can estimate range of the UAV 110. Thus, the combination of Doppler and FM radars can allow determination of the existence, velocity, and range of the UAV 110 simultaneously by a processor (such as, but not limited to, the processor 230). The radar-based identification apparatus 530 may output third identity data 535, which may include at least some characteristics of the UAV 110, such as the existence, velocity, and range of the UAV 110. In addition or alternatively, the third identity data 535 may include at least one potential identity of the UAV 110 determined based on the radar data.

In some examples, the fusion identification apparatus 500 may additionally or alternatively include a wireless control identification apparatus 540. The wireless control identification apparatus 540 may include or be coupled to at least one wireless receiver 542a for receiving control signals received by or transmitted from the UAV 110. The wireless control identification apparatus 540 may include a processor (such as, but not limited to, the processor 230) configured to extract control information related to the identity of the UAV 110 from the control signals. The wireless control identification apparatus 540 may output a fourth identity data 545, which includes the identity of the UAV 110 based on the control information. The fourth identity data 545 may include (additionally or alternatively) other suitable information related to the UAV 110 extracted from the control signals.

In some examples, the fusion identification apparatus 500 may additionally or alternatively include an infrared identification apparatus 550. The infrared identification apparatus 550 may include or is coupled to at least one infrared or thermal sensor 552a for detecting a thermal signature of the UAV 110. The infrared identification apparatus 550 may complement the video/image-based identification apparatus 520 given that the infrared identification apparatus 550 can be operable after dark. The infrared identification apparatus 550 may include a processor (such as, but not limited to, the processor 230) configured to compute a correlation between the detected heat signature of the UAV 110 with stored heat signatures associated with various UAV identities. The infrared identification apparatus 550 may output a fifth identity data 555 which includes a determined identity of the UAV 110 (one with the highest correlation). In further examples, the fifth identity data 555 may include a ranked list of “best estimates” based on the processes of the infrared identification apparatus 550. For example, the fifth identity data 555 may include multiple potential identities for the UAV 110 and correlation coefficients (or other suitable indicators of confidence level) associated with each of these potential identities.

A fusion engine 570 may be used to combine one or more of the identity data (e.g., the first identity data 515, second identity data 525, third identity data 535, fourth identity data 545, and fifth identity data 555) corresponding to various types of sensors to determine identity and characteristics of the approaching UAV 110. Particularly, the identity data 515, 525, 535, 545, and 555 can be correlated to further improve confidence level of the identification and characteristics. In some examples, the identity data 515, 525, 535, 545, and 555 may be time-aligned using timestamps. In some examples, each of the identity data 515, 525, 535, 545, and 555 may be weighted, for instance, based on the level of correlation associated with a potential UAV identity or based on the type of sensors used in determining the potential UAV identity. The UAV identity with the highest weighted score among all potential UAV identities included in the identity data 515, 525, 535, 545, and 555 may be selected to be the UAV identity for the UAV 110 and outputted in identification data 580. Further characteristics such as, but not limited to, the existence of the UAV 110, speed, direction, range, altitude, and the like may be outputted as the characteristic data 590.

One or more of the identification data 580 and the characteristic data 590 may be provided to a user on a display (not shown) or other indication device, stored (e.g., in a memory or database) for future reference, or the like. In some examples, one or more of the identity data 515, 525, 535, 545, and 555 may not include a potential identity or a closest match for the UAV 110. Each of the identity data 515, 525, 535, 545, and 555 may include at least some information and/or characteristics related to the UAV 110 that can be used by components of the fusion identification apparatus 500 to determine the identity of the UAV 110 as described.

Each of the acoustic-based identification apparatus 200, the acoustic-based identification apparatus 510, video/image-based identification apparatus 520, radar-based identification apparatus 530, wireless control identification apparatus 540, infrared identification apparatus 550, and fusion engine 570 may include its own respective processors, memories, and databases for the functions described herein. In other examples, two or more of the apparatuses 200, 510, 520, 530, 540, 550, and 570 may share a same processor, memory, and/or databases for performing the functions described herein.

FIG. 6A is a schematic diagram illustrating a visual sensor array 600a according to various examples. Referring to FIGS. 1-6A, the visual sensor array 600a may correspond to an arrangement of the visual sensors 522a-522n according to various examples. The visual sensor array 600a may include visual sensors (e.g., the visual sensors 522a-522n) arranged in a half-dome configuration (or other-shaped configuration) to capture video streams or images of the UAV 110. The visual sensor array 600a may form a half-dome in a plane parallel or nonparallel to the ground level. At least one additional half-dome such as the visual sensor array 600a may be added (in a same or different plane) in further examples. While the half-dome visual sensor array 600a is illustrated herein, additional or alternative visual sensor arrays such as, but not limited to, a planar array, may be implemented.

FIG. 6B is a schematic diagram illustrating the video/image-based identification apparatus 520 according to various examples. Referring to FIGS. 1-6B, the video-image-based identification apparatus 520 may include a processor 630, memory 640, and database 650 such as, but not limited to, the processor 230, memory 240, and database 250 of the acoustic-based identification apparatus 220, respectively. The database 650 may store known contours associated various types of UAVs. The database 650 may also store known motion vectors associated with different maneuvers performed by the various types of UAVs. As described, the video/image-based identification apparatus 520 may include or be coupled to the visual sensors 522a-522n and output the second identity data 525.

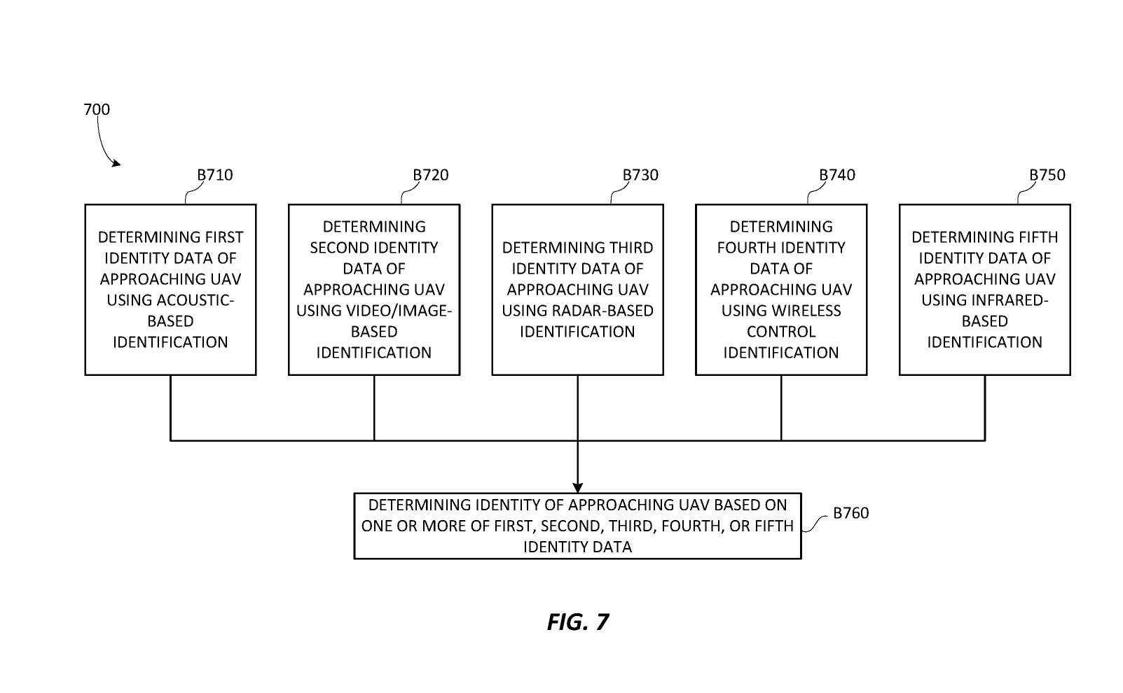

FIG. 7 is a process flow diagram illustrating a UAV identification method 700 using a fusion identification apparatus according to various examples. Referring to FIGS. 1-7, the UAV identification method 700 may be implemented by the fusion identification apparatus 500 according to various examples. Blocks B710-B760 are presented for illustrative purposes, and one of ordinary skill in the art would appreciate that examples having fewer or additional blocks as compared to blocks B710-B760 may likewise be implemented when feasible and/or desired.

At block B710, the processor 230 of the acoustic-based identification apparatus 510 may be configured to determine the first identity data 515 of the approaching UAV 110 using the acoustic-based identification in the manner described. At block B720, the processor 630 of the video/image-based identification apparatus 520 may be configured to determine the second identity data 525 of the approaching UAV 110 using the video/image-based identification in the manner described.

At block B730, the processor of the radar-based identification apparatus 530 may be configured to determine the third identity data 535 of the approaching UAV 110 using the radar-based identification in the manner described. At block B740, the processor of the wireless control identification apparatus 540 may be configured to determine the fourth identity data 545 of the approaching UAV 110 using the wireless control identification method in the manner described.

At block B750, the processor of the infrared identification apparatus 550 may be configured to determine the fifth identity data 555 of the approaching UAV 110 using the infrared-based identification in the manner described.

At block B760, the processor of the fusion engine 570 may be configured to determine the identity of the approaching UAV 110 based on one or more of the first, second third, fourth, or fifth identity data 515, 525, 535, 545, or 555.

In some examples, in response to one of the apparatuses of the fusion identification apparatus 500 determining an existence or presence of the UAV 110 (e.g., the UAV 110 is within the identification boundary 135), one or more of the other apparatuses (or components thereof) may be activated. For example, the existence of the UAV 110 may be determined in response to the acoustic-based identification apparatus 510 determining a particular frequency, maneuver, acoustic signature delta, or acoustic signature that is uniquely associated with UAVs as compared to other flying objects. Illustrating with a non-limiting example, the existence of the UAV 110 may be determined when the captured frequency is within a range of rotor frequencies including frequencies associated with all potential UAVs. In another non-limiting example, the existence of the UAV 110 may be determined by the video/image-based identification apparatus 520 in response to detecting a flying object having an expected size of a UAV, flying in trajectory or pattern similar to that a UAV, and/or other characteristic(s) associated with a UAV. In another non-limiting example, the existence of the UAV 110 may be determined by one or more of the other apparatuses (e.g., the radar-based identification apparatus 530, the wireless control identification apparatus 540 capturing control signals of the UAV 110, the infrared identification apparatus 550 detecting a thermal signature within an acceptable degree of similarity of thermal signatures of UAVs, and/or the like. In response to determining the existence of the UAV 110, one or more other apparatuses may be activated and/or associate their respective data together with the detected UAV 110.

Data from one or more of the apparatuses of the fusion identification apparatus 500 may be associated with one another using timestamps. For example, in response to one of the apparatuses detecting the existence of the UAV 110, a first timestamp may be sent to the other apparatuses to associate their processes, starting from a time indicated by the first timestamp, with the same UAV 110. When one of the apparatuses detects that the UAV 110 is outside of the identification boundary 135 or that the UAV 110 (and/or characteristics thereof) has been at least partially identified, a second timestamp may be sent to other apparatuses. The second timestamp may indicate ending of data collection for the UAV 110. Raw data collected between the first and the second timestamp may be used to determine other identity data (e.g., the first, second third, fourth, and/or fifth identity data 515, 525, 535, 545, and/or 555). The first, second third, fourth, and/or fifth identity data 515, 525, 535, 545, and/or 555 may be sent to the fusion engine 570 for determining the identification data 580 with the associated timestamps. The processor of the fusion engine 570 may be configured to associate the first, second third, fourth, and/or fifth identity data 515, 525, 535, 545, and/or 555 with the corresponding timestamps.

As described herein, each of the first, second third, fourth, and/or fifth identity data 515, 525, 535, 545, and/or 555 may include one or more potential identities and/or characteristics of the UAV 110. The outputted identity (corresponding to the identification data 580) of the fusion identification apparatus 500 may be determined based on a weighted score for each of the potential identities included in the first, second third, fourth, and/or fifth identity data 515, 525, 535, 545, and/or 555. Particularly, the potential identity with the highest weighted score, or the potential identity that crosses a predetermined threshold may be outputted in the identification data 580.

In some examples, the weighted score for each of the potential identities may be biased based on the type of sensors and apparatuses used in obtaining the result. Illustrating with a non-limiting example, the weighted score (“S”) for a potential identity included in at least one of the first, second third, fourth, and fifth identity data 515, 525, 535, 545, and 555 may be computed by

S=A*xₐ+B*xᵥ+C*xᵣ+D*x_{w}+E*xᵢ (1)

where A is a scaling factor associated with the acoustic-based identification, B is a scaling factor associated with the video/image-based identification, C is a scaling factor associated with the radar-based identification, D is a scaling factor associated with the wireless control identification, and E is a scaling factor associated with the infrared identification. Examples of A-E may include, but not limited to, 0.5, 1, 2, 10, 100, and/or the like. Each of xₐ, xᵥ, xᵣ, x_{w}, and xᵢ, may represent whether the same identity has been included in each of the first, second third, fourth, and fifth identity data 515, 525, 535, 545, and 555, respectively. In some examples, the values of each of the xₐ, xᵥ, xᵣ, x_{w}, and xᵢ may be binary (i.e., 0 indicates exclusion and 1 indicates inclusion).

In some examples, the scaling factors A-E may be set based on the accuracy of the detection and identification method. For example, B may be higher than A, C, D, and E during the day (compared to at night) given that B may be considered to implement visual identification methods that provide higher degrees of accuracy during daylight hours. In alternative examples, the type of sensors and apparatus used does not influence S (e.g., A-E may each be 1).

In some examples, the weighted score (S) may be alternatively or additionally biased based on the degree of correlation (e.g., confidence level) associated with the particular potential identity outputted in at least one of the first, second third, fourth, and fifth identity data 515, 525, 535, 545, and 555. For example, each of xₐ, xᵥ, xᵣ, x_{w}, and xᵢ may be a value indicating a degree of correlation (e.g., a correlation coefficient or an average correlation value) with the potential identity, instead of a binary number. In particularly examples, the more correlated the captured data with the potential identity, the higher the correlation coefficient may be. A higher correlation coefficient may increase the weighted score (S), vice versa.

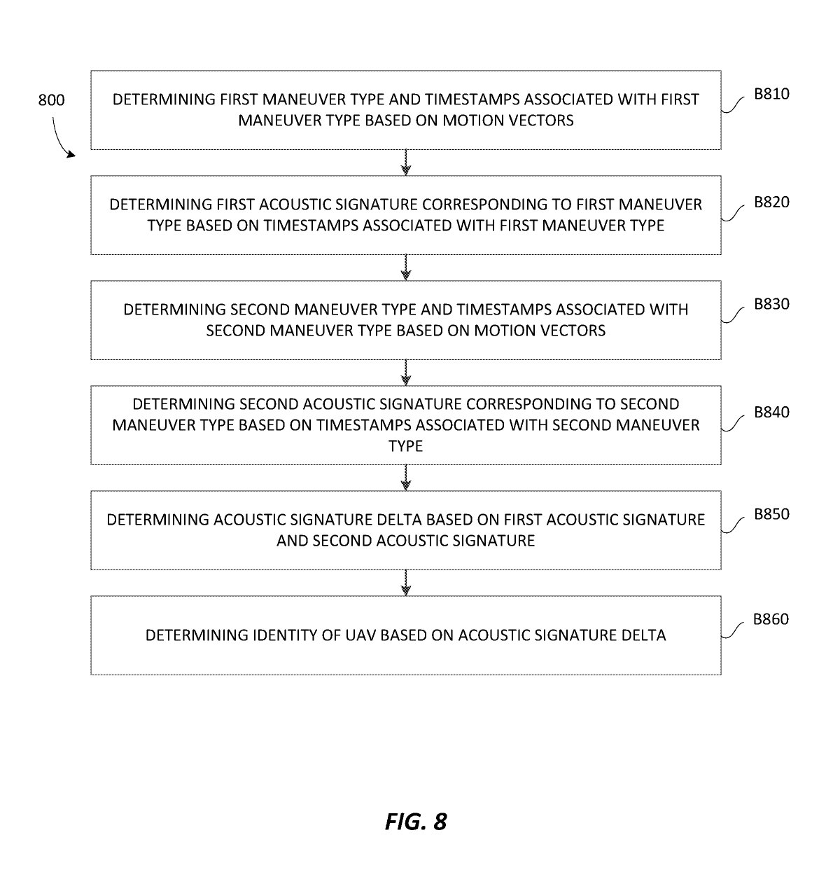

FIG. 8 is a process flow diagram illustrating a UAV identification method 800 using the acoustic-based identification apparatus (200, 510 in FIGS. 2 and 5) and the video/image-based identification apparatus 520 (FIGS. 5 and 6B) according to various examples. Referring to FIGS. 1-8, the processor 630 of the video/image-based identification apparatus 520 may be configured to determine the first maneuver type based on the motion vectors associated with the UAV 110, at block B810, in some examples.

For example, the processor 630 may be configured to match the motion vectors of the UAV 110 with a known/stored set of motion vectors associated with a particular maneuver type in response to determining that a size of the at least one object in the video streams corresponds to a size of a UAV. That is, the processor 630 may identify the first maneuver type performed by the UAV 110 by selecting one from a plurality of potential maneuver types based on correlation with the captured motion vectors of the UAV 110. When the first maneuver type is identified, a timestamp is stored (in the memory 240 and/or the memory 640) for the beginning of the first maneuver and another time stamp is stored (in the memory 240 and/or the memory 640) for the end of the first maneuver. The timestamps may be sent to or accessed by the processor 230 of the acoustic-based identification apparatus 200 (510). Illustrating with a non-limiting example, the processor 630 may determine that the motion vectors from the visual data captured by the visual sensor array 600a are consistent with banking left (e.g., the first maneuver type in FIG. 4B). The processor 630 may store T₁ 440b and T₂ 450b in the memory 240 and/or the memory 640.

In some examples, the processor 230 of the acoustic-based identification apparatus 200 may determine the first acoustic signature corresponding to the first maneuver type, at block B820. The first acoustic signature may be determined based on the timestamps associated with the first maneuver type. Returning to the non-limiting example, based on T₁ 440b and T₂ 450b determined by the processor 630, the processor 230 can determine the first acoustic signature 472b corresponding to the first maneuver type. The first acoustic signature 472b may be the acoustic signature between T₁ 440b and T₂ 450b

In some examples, at block B830, the processor 630 of the video/image-based identification apparatus 520 may determine the second maneuver type associated with the second maneuver type based on the motion vectors in a manner similar to described with respect to the first maneuver type at block B810. In some examples, at block B840, the processor 230 of the acoustic-based identification apparatus 200 may determine the second acoustic signature 474b corresponding to the second maneuver type in a manner similar to described with respect to the first acoustic signature at block B820. For example, the second acoustic signature 474b may be determined based on the timestamps (T₂ 450b and T₃ 460b) associated with the second maneuver type.

Thus, the first and second maneuver types of the UAV 110 may be identified by the video/image-based identification apparatus 520 (and/or via other apparatuses) instead of the acoustic-based identification apparatus 200. Each of blocks B810 and B830 may be repeated until the first and second maneuver types can be determined or a best maneuver type match can be found. In further examples, both the video/image-based identification apparatus 520 and the acoustic-based identification apparatus 200 may be configured to determine the first and second maneuver types for improved accuracy. In such examples, each of blocks B810 and B830 may be repeated until both apparatuses 200 and 520 select the same maneuver type for each of the first and second maneuver types.

In some examples, at block B850, the processor 230 of the acoustic-based identification apparatus 200 may determine the acoustic signature delta based on the first acoustic signature and the second acoustic signature in a manner similar to described with espect to block B460a. In some examples, at block B860, the processor 230 of the acoustic-based identification apparatus 200 may determine the identity of the UAV 110 based on the acoustic signature delta in a manner similar to described with respect to block B470a.

In some examples, the processor 230 and the processor 630 may be a same processor. In other examples, the processor 230 and the processor 630 are separate processors. In some examples, the memory 240 and the memory 640 may be a same memory. In other examples, the memory 240 and the memory 640 are different memories. In further examples, one or more processes described with respect to the methods 400a, 700, 800, and the like) described herein may be implemented with machine learning.

Some examples described herein relate to collaborative detection and management of UAVs using a plurality of detection devices. Each detection device may be a device such as, but not limited to, the identification apparatus 120, acoustic-based identification apparatus 200, video/image-based identification apparatus 520, radar-based identification apparatus 530, wireless control identification apparatus 540, infrared identification apparatus 550, fusion identification apparatus 500, an unmanned vehicle (e.g., a UAV) having capabilities of one or more of the apparatuses 120, 200, 500, 520, 530, 540, and 550, a mobile device having capabilities of one or more of the apparatuses 120, 200, 500, 520, 530, 540, and 550, and/or the like. Each detection device may detect a UAV in a detection area defined by sensors provided therein (e.g., defined by the identification boundary 135). Two detection devices may be adjacent to each other when the detection areas of the detection devices overlap or contact with each other, or when no additional detection area or associated additional detection device is between the detection areas of the two detection devices.

Information related to a UAV detected by a first detection device in a first detection area may be shared with other detection devices (e.g., a second detection device) through a direct link (or via an intermediary device) between the first detection device and the second detection device or through a central server. The information may include one or more of (1) sensor data outputted by at least one sensor of the first detection device; (2) identity data such as, but not limited to, the identity data 515-555, output signal 260, identification data 580, or the like that may indicate an identity of the UAV; (3) the characteristic data 590 indicating one or more of the existence, speed, direction, range, altitude of the UAV 110, or the like; or (4) secondary data such as, but not limited to, timestamp at which the sensor data, identity data, or characteristic data is determined by the first detection device. In some examples, a trust factor may be associated with the information sent to the second detection device. The trust factor may be sent with the information to the second detection device to indicate a level of confidence associated with the information in some examples. In other examples, the trust factor may be determined at the second detection device and/or the central server.

The second detection device may use the sensor data received from the first detection device alone or in combination with any sensor data detected by at least one sensor of the second detection device (and/or sensor data received from other detection devices) to determine the identity of the UAV. The second detection device may identify the UAV based on the identity data received from the first detection device. The second detection device may use the characteristic data 590 obtained from the first detection device as initial values for determining the characteristic data 590 within a second detection area associated with the second detection device. The second detection device may determine and/or update the trust factor of the first detection device based on the secondary data.

Accordingly, the second detection device may determine the identity of the UAV by leveraging the information received from the first detection device (and/or other detection devices). For instance, the second detection device may not need to perform additional detection in some examples given that the identity data may be trustworthy (e.g., indicated by the trust factor crossing a threshold). This may be useful if the second detection device does not have certain detection capabilities and/or resources, the detection capabilities (e.g., sensor sensitivities or accuracies) and/or resources of the second detection device may be lower than those of the first detection device, or the like. In some examples, the second detection device may perform additional detection and analysis based on the information received from the first detection device to determine the identity of the UAV, thus reducing processing intensity and/or increasing likelihood of correct identification by providing additional sampling.

In some examples, the first detection device may send the information to all adjacent (or otherwise nearby) detection devices. In other examples, the first detection device may select one or more of the adjacent detection devices to send information. For instance, the first detection device may select one or more of the adjacent detection devices based on the characteristic data 590, geographical boundaries of the detection areas of the first detection device, geographical boundaries of the detection area of the adjacent detection devices, and/or the like. That is, the first detection device may determine one or more adjacent detection areas that the UAV may enter and/or an Expected Time of Arrival (ETA) at which the UAV may enter the one or more adjacent detection areas. The first detection device may send the information related to the UAV to adjacent detection devices associated with the one or more adjacent detection areas that the UAV may enter at or approximated at the ETA.

In some examples, the flow of information from one detection device to another detection device may be managed by the central server, which may include additional processing power and memory storage than one or more of the detection devices. Each of the detection devices can be linked to the control server for collective determination of the identities of the UAVs, thus conserving networking economy. Centralized management of a large number of UAVs traveling within detection areas of a large number of detection devices may also be preferred for data management reasons.

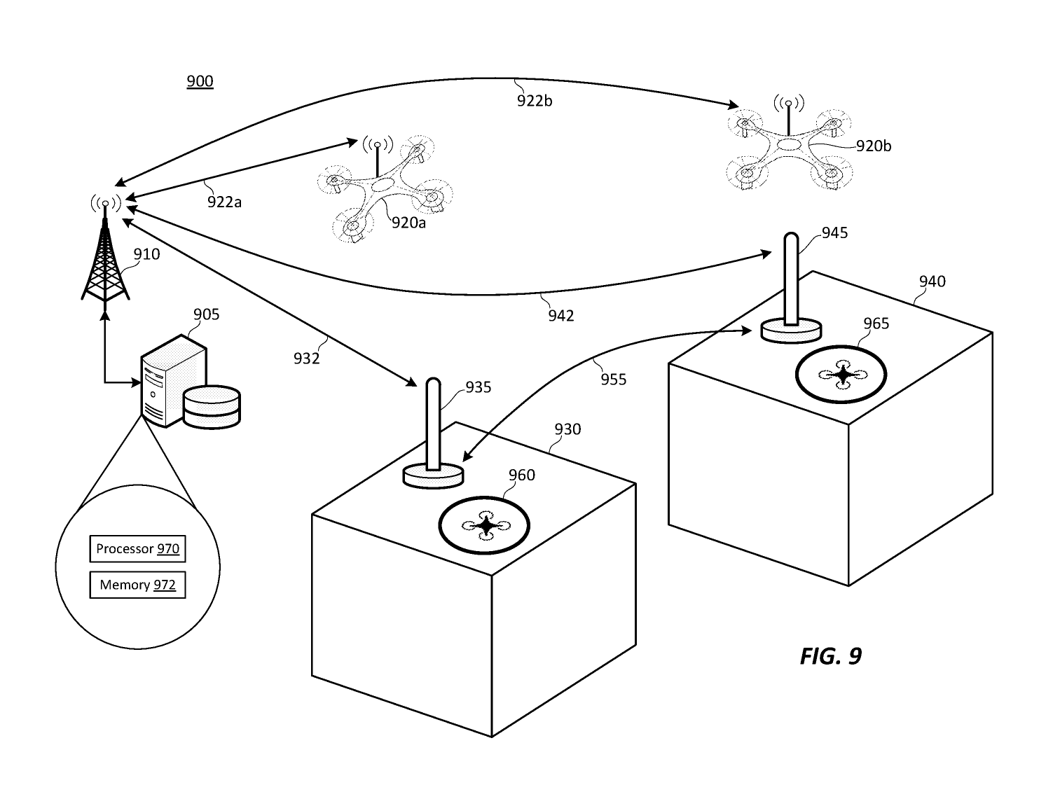

FIG. 9 is a diagram illustrating a collaborative UAV detection and management system 900 for identifying UAVs 920a and 920b (e.g., which may correspond to the UAV 110 of FIGS. 1-8) according to various examples. Referring to FIGS. 1-9, the collaborative UAV detection and management system 900 may include a first detection device 935 arranged on a first structure 930 (or other suitable location) and a second detection device 945 arranged on a second structure 930 (or other suitable location). Each of the first detection device 935 and the second detection device 945 may be arranged on the respective structures 930 and 945 in a manner similar to described with respect to the identification apparatus 120 and the structure 130. In some examples, each of the structures 930 and 945 may include charging and landing stations 960 or 965, respectively, for nearby UAVs to charge and to land.

One or more of the first detection device 935 and the second detection device 945 may be a device such as, but not limited to, the identification apparatus 120, acoustic-based identification apparatus 200, video/image-based identification apparatus 520, radar-based identification apparatus 530, wireless control identification apparatus 540, infrared identification apparatus 550, fusion identification apparatus 500, an unmanned vehicle (e.g., a UAV) having capabilities of one or more of the apparatuses 120, 200, 500, 520, 530, 540, and 550, a mobile device having capabilities of one or more of the apparatuses 120, 200, 500, 520, 530, 540, and 550, and/or the like. One or more of the first detection device 935 and the second detection device 945 may detect aspects of the UAVs 920a and 920b and/or determine identities of the UAVs 920a and 920b. In some examples, each of the first detection device 935 and second detection device 945 in the collaborative UAV detection and management system 900 may have some detection and/or identification capabilities. In other examples, one or more of the first detection device 935 and second detection device 945 may lack any detection and/or identification capabilities. The technique, types of sensors, accuracy/resolution of the sensors for detecting identifying the UAVs 920a and 920b may vary across the detection devices 935 and 945 in the collaborative UAV detection and management system 900.

The first detection device 935 and the second detection device 945 may be coupled through a network link 955 for direct sharing of the information determined with respect to the UAVs 920a and/or 920b. The network link 955 may include any suitable wired or wireless networking protocol. In some examples, the network link 955 may be, but not limited to, the Internet, or one or more Intranets, local area networks (LANs), Ethernet networks, metropolitan area networks (MANs), a wide area network (WAN), combinations thereof, and/or the like. In particular examples, the network link 955 may represent one or more secure networks configured with suitable security features, such as, but not limited to firewalls, encryption, or other software or hardware configurations that inhibits access to network communications by unauthorized personnel or entities.

In some examples, the collaborative UAV detection and management system 900 may include a central server 905 for centralized management of UAV detection and management. The central server 905 may include a processor 970 and memory 972. The processor 970 may be a general-purpose processor. The processor 970 may include any suitable data processing device, such as, but not limited to, a microprocessor, CPU, or custom hardware. In some examples, the processor 970 may be any suitable electronic processor, controller, microcontroller, or state machine. The processor 970 may be implemented as a combination of computing devices (e.g., a combination of a DSP and a microprocessor, a plurality of microprocessors, at least one microprocessor in conjunction with a DSP core, or any other suitable configuration). According to some examples, the memory 972 may be a non-transitory processor-readable storage medium that stores processor-executable instructions. The memory 972 may include any suitable internal or external device for storing software and data. Examples of the memory 972 may include, but are not limited to, RAM, ROM, floppy disks, hard disks, dongles, or other RSB connected memory devices, or the like. The memory 972 may store an OS, user application software, and/or executable instructions. The memory 972 may also store application data, such as, but not limited to, an array data structure. The memory 972 may include a database such as, but not limited to, a Structured Query Language (SQL) server or another suitable database for storing the information related to the UAVs 920a and 920b.

In some examples, the central server 905 may be coupled to a network device 910, which may include at least one antenna or transmission station located in the same or different areas, associated with signal transmission and reception. The network device 910 may include one or more processors, modulators, multiplexers, demodulators, demultiplexers, antennas, and the like for performing communication functions described herein. The network device 910 may establish network links 922a, 922b, 932 and/or 942 with one or more of the UAVs 920a and 920b and detection devices 935 and 940, respectively. Each network link 922a, 922b, 932, or 942 may be made through a protocol such as, but not limited to, the Internet, or one or more Intranets, LANs, Ethernet networks, MANs, a WAN, combinations thereof, and/or the like. In some examples, each network link 922a, 922b, 932, or 942 may represent one or more secure networks configured with suitable security features, such as, but not limited to firewalls, encryption, or other software or hardware configurations that inhibits access to network communications by unauthorized personnel or entities

In some examples, each of the network device 910, first detection device 935, and second detection device 945 may be an access point, Node B, evolved Node B (eNodeB or eNB), base transceiver station (BTS), or the like in communication with one another and/or with the UAVs 920a and 920b.

In some examples, the central server 905 may receive the information via the network link 932 related to one or more of the UAVs 920a and 920b as determined by the first detection device 935, and relay the information to the second detection device 945 via the network link 942. In some examples, the central server 905 may not be needed, as the detection devices 935 and 945 may share the information with each other through the direct network link 955. In some examples, the central server 905 may receive signals from one or more of the UAVs 920a or 920b, such signals may include GPS signals, video/image signals, or the like. The central server 905 may also send signals such as, but not limited to, location updates (as determined by the detection devices 935 and 945), the characteristic data (e.g., speed, direction, range, altitude, and/or the like), control signals, and/or the like to one or more of the UAVs 920a or 920b. In some examples, the network device 910 may be the antenna 371. The central server 905 may be the wireless communication device 370.

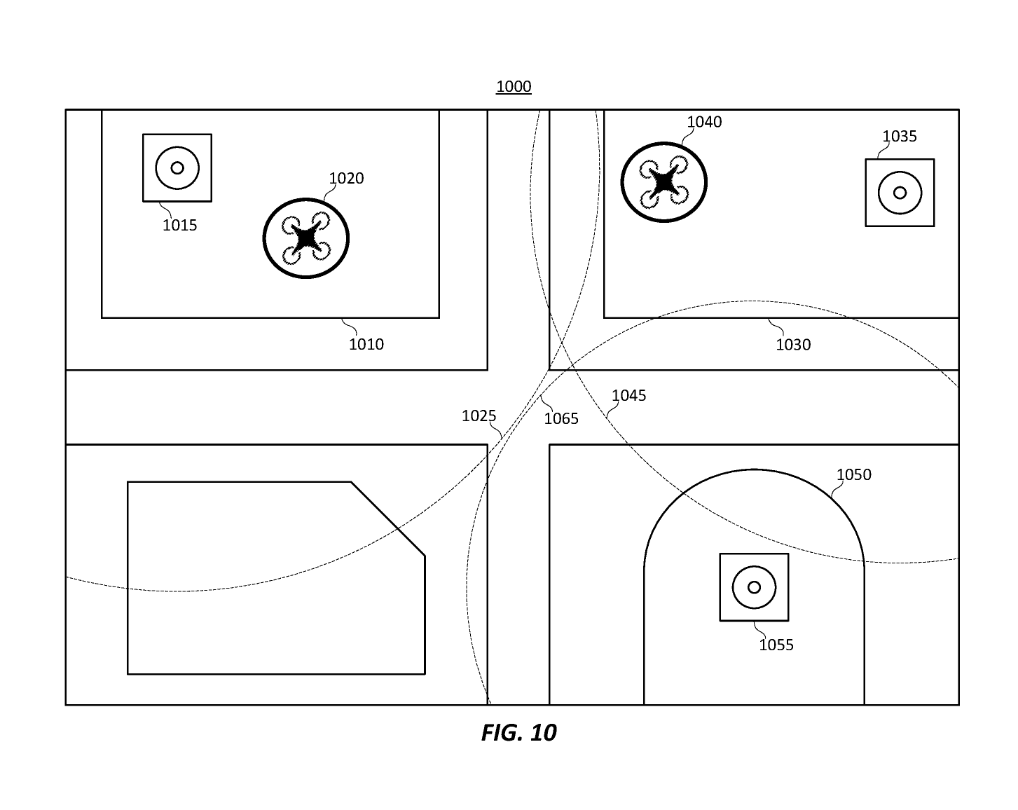

FIG. 10 is a diagram illustrating a deployment arrangement of a collaborative UAV detection and management system 1000 according to various examples. FIG. 10 is a top view of structures (or locations) 1010, 1030, and 1050. Referring to FIGS. 1-10, the collaborative UAV detection and management system 1000 may be an implementation of the collaborative UAV detection and management system 900 in some examples. For instance, the collaborative UAV detection and management system 1000 may include detection devices 1015, 1035, and 1055, each of which is arranged on a respective one of the structures 1010, 1030, and 1050. Each detection device 1015, 1035, or 1055 may be a device such as, but not limited to, the first detection device 935 or the second detection device 945. IN some examples, charging and landing stations 1020 and 1040 may be arranged on structures 1010 and 1030, respectively, for nearby UAVs to charge and to land.

In some examples, the detection device 1015 may be configured to detect a UAV in a detection area 1025 with sensors provided to the detection device 1015. The detection device 1035 may be configured to detect a UAV in a detection area 1045 with sensors provided to the detection device 1035. The detection device 1055 may be configured to detect a UAV in a detection area 1065 with sensors provided to the detection device 1055.

The detection devices 1015, 1035, and 1055 may be adjacent to one another. Accordingly, based on the size of the detection areas (e.g., 1025, 1045, and 1065), detection devices (e.g., 1015, 1035, and 1055) may be strategically deployed to achieve desired coverage area, which is a sum of the detection areas.

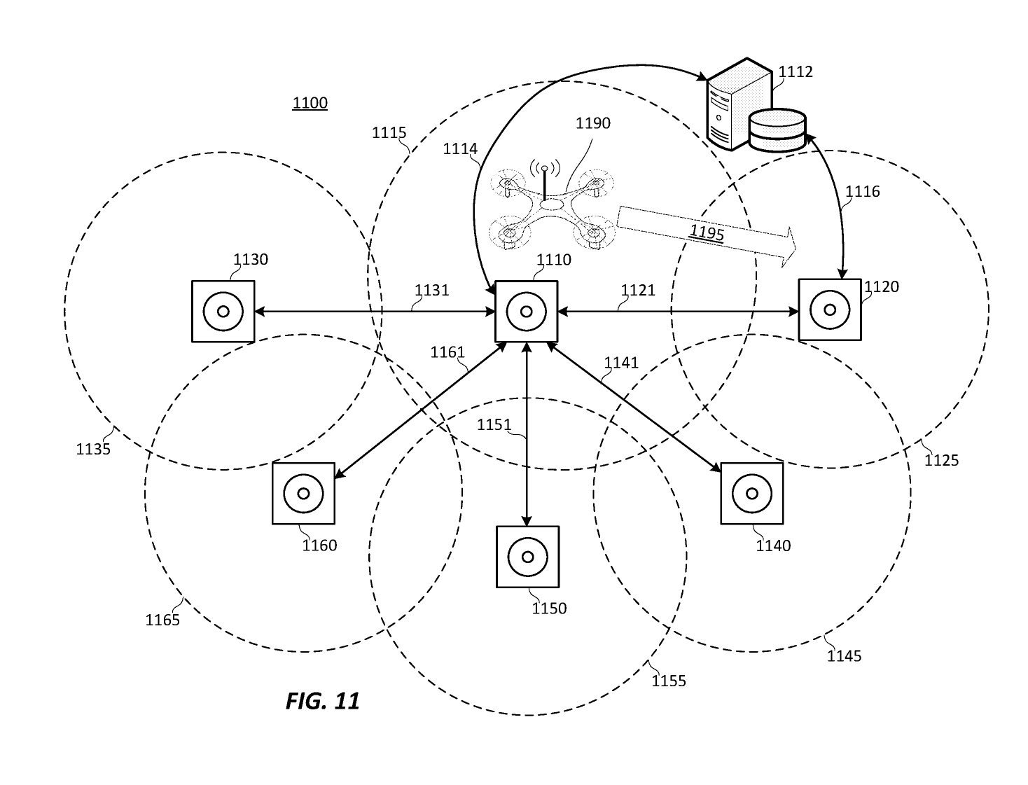

FIG. 11 is a diagram illustrating handover mechanism for handing over information related to a UAV 1190 from a first detection device 1110 to a second detection device 1120 in a collaborative UAV detection and management system 1100 according to various examples. Referring to FIGS. 1-11, the collaborative UAV detection and management system 1100 may be similar to described with respect to the collaborative UAV detection and management system 900 and 1000. For example, each of detection devices 1110, 1120, 1130, 1140, 1150, and 1160 may be a device such as, but not limited to, the detection device 935, 945, 1015, 1035, or 1055. One or more of the detection devices 1110, 1120, 1130, 1140, 1150, and 1160 may be configured to detect and/or identify a UAV within a respective one of detection areas 1115, 1125, 1135, 1145, 1155, and 1165.

The sizes of the detection areas 1115, 1125, 1135, 1145, 1155, and 1165 may vary depending on types of sensors, accuracy/resolution of the sensors, environmental conditions within each of the detection areas 1115, 1125, 1135, 1145, 1155, and 1165, and/or the like. Illustrating with a non-limiting example, a video camera may detect UAVs in a larger detection area than an acoustic microphone array in some cases. Illustrating with another non-limiting example, a high-resolution microphone array may detect UAVs in a larger detection area than a low-resolution microphone array. Illustrating with yet another non-limiting example, a video camera may detect UAVs in a larger detection area than an acoustic microphone array when and if the detection area produces a considerable amount of noise pollution. The sizes of the detection areas may vary dynamically based on environment conditions such as, but not limited to, time of day, temperature, noise, wind, interferences, a combination thereof, and/or the like.

The UAV 1190 may be a UAV such as, but not limited to, the UAV 110, 920a, 920b, or the like. The UAV 1190 may have movement characteristics 1195 such as, but not limited to, position, speed, direction, or altitude. The movement characteristics 1195 may be captured by the first detection device 1110 based on sensor data and outputted as, for example, the characteristic data 590.

The first detection device 1110 may be adjacent to (may neighbor) the neighbor detection devices 1120, 1130, 1140, 1150, and 1160. The second detection device 1120 may be one of the neighbor detection devices 1120, 1130, 1140, 1150, and 1160. Consistent with the movement characteristics 1195, the UAV 1190 may be projected to exit the first detection area 1115 and enter the second detection area 1125 at a certain ETA.

The first detection device 1110 may be connected to each of the neighbor detection devices 1120, 1130, 1140, 1150, and 1160 via inter-detection device network links 1121, 1131, 1141, 1151, and 1161, respectfully. Each of the network links 1121, 1131, 1141, 1151, and 1161 may be a network link such as, but not limited to, the network link 955. The network links 1121, 1131, 1141, 1151, and 1161 may be used to communicate information regarding the UAV 1190. For the sake of clarity, network links among the neighbor detection devices 1120, 1130, 1140, 1150, and 1160 are not shown.

In some examples, a central server 1112 (such as, but not limited to, the central server 905) may be employed in the collaborative UAV detection and management system 1100. The central server 1112 may connect to the first detection device 1110 via a network link 1114 (such as, but not limited to, the network link 932). The central server central server 1112 may connect to the second detection device 1112 via a network link 1116 (such as, but not limited to, the network link 942). For the sake of clarity, network links between the central server 1112 and each of the neighbor detection devices 1130, 1140, 1150, and 1160 are not shown. In some examples, the information related to the UAV 1190 may be received by the central server 1112 from the first detection device 1110 via the network link 1114. The central server 1112 may relay the information to the second detection device 1112 via the network link 1116. In other examples, the central server 1112 may not be provided, and the information may be shared via the inter-detection device network links 1121, 1131, 1141, 1151, and 1161.

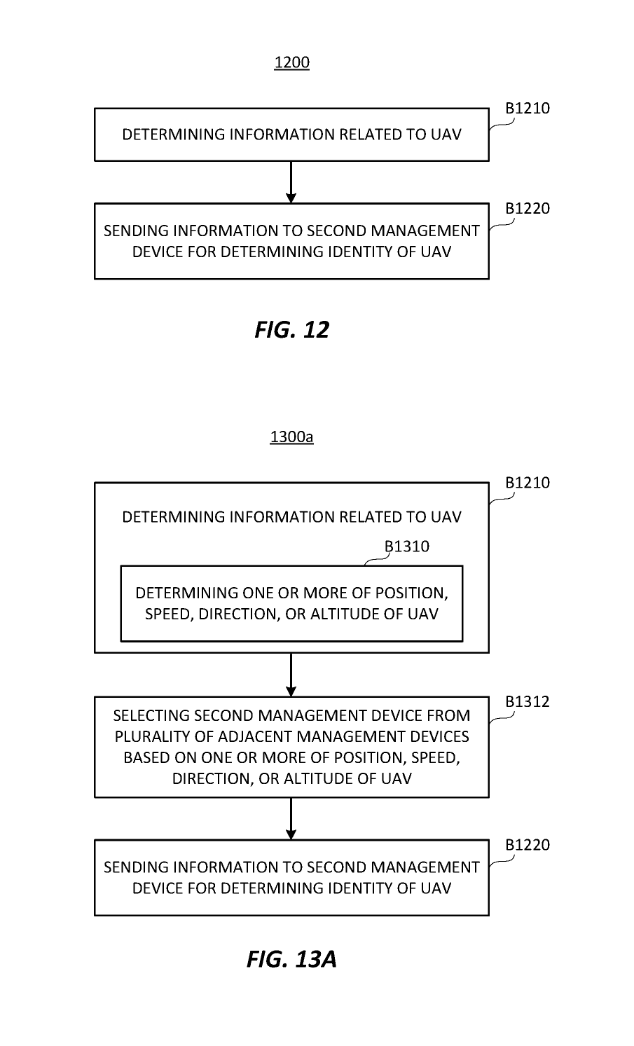

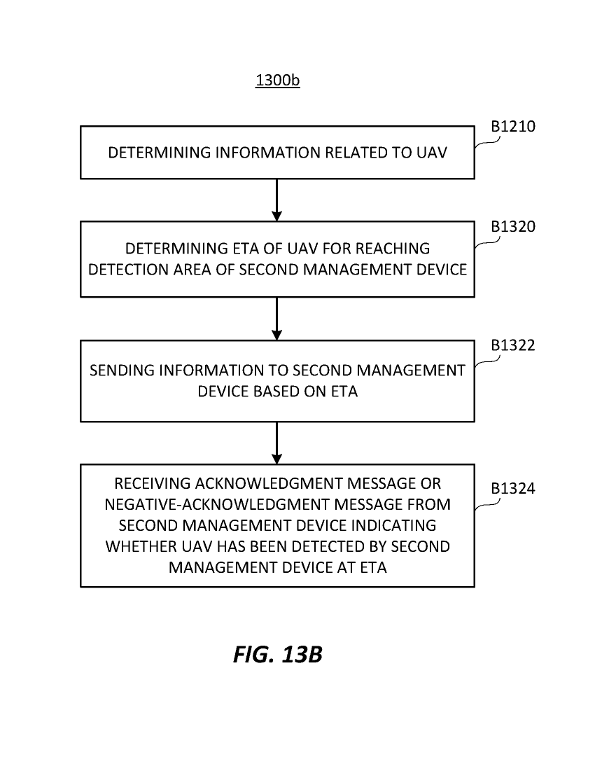

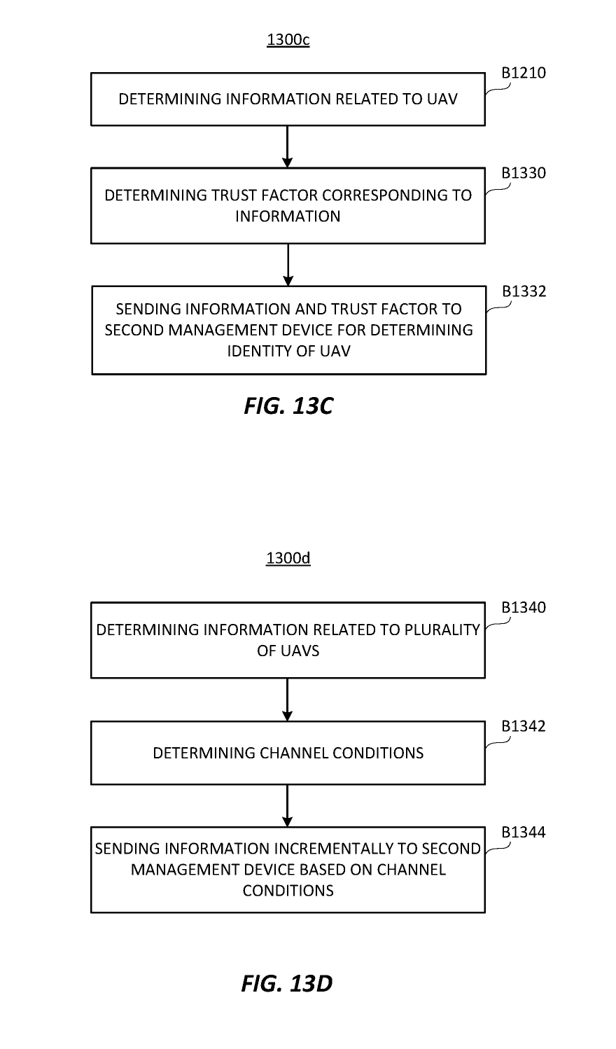

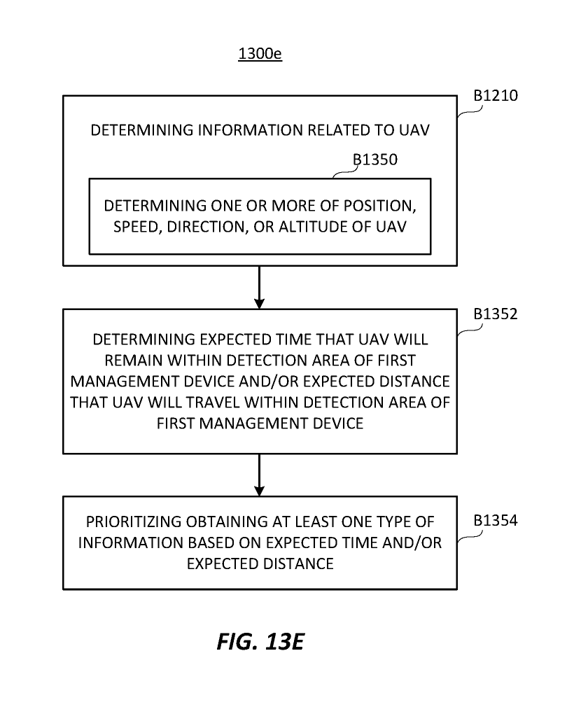

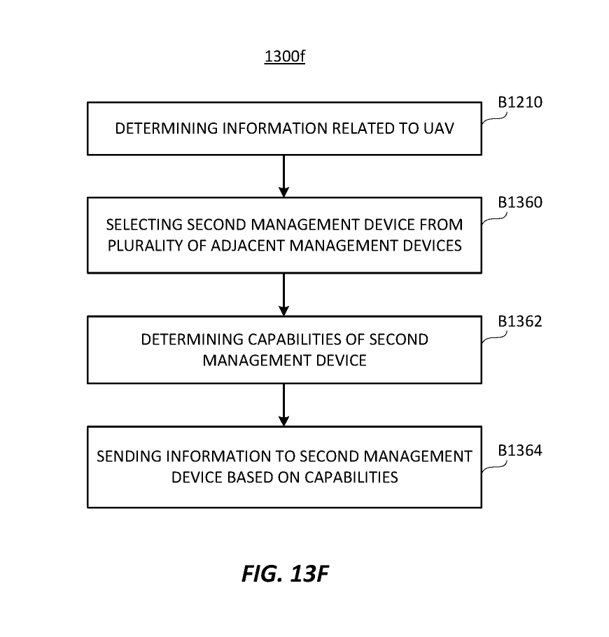

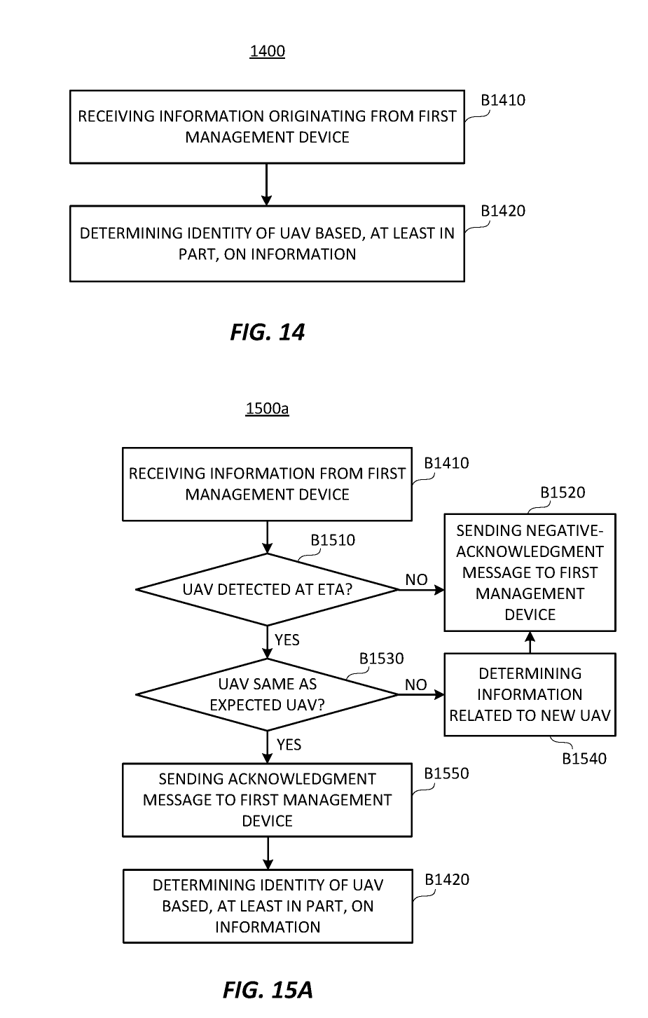

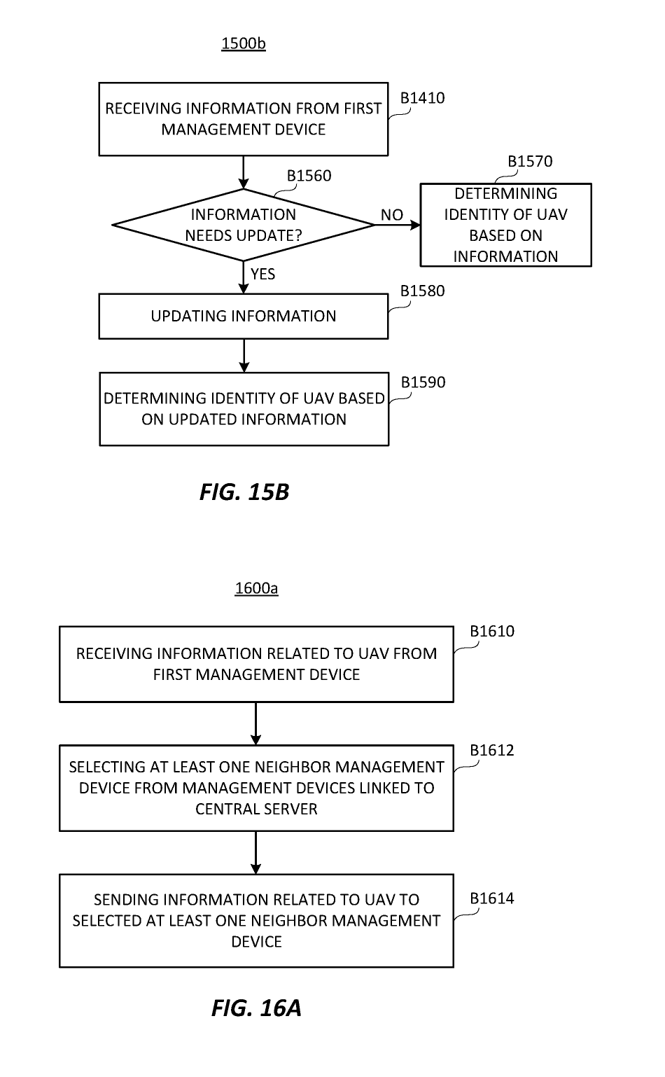

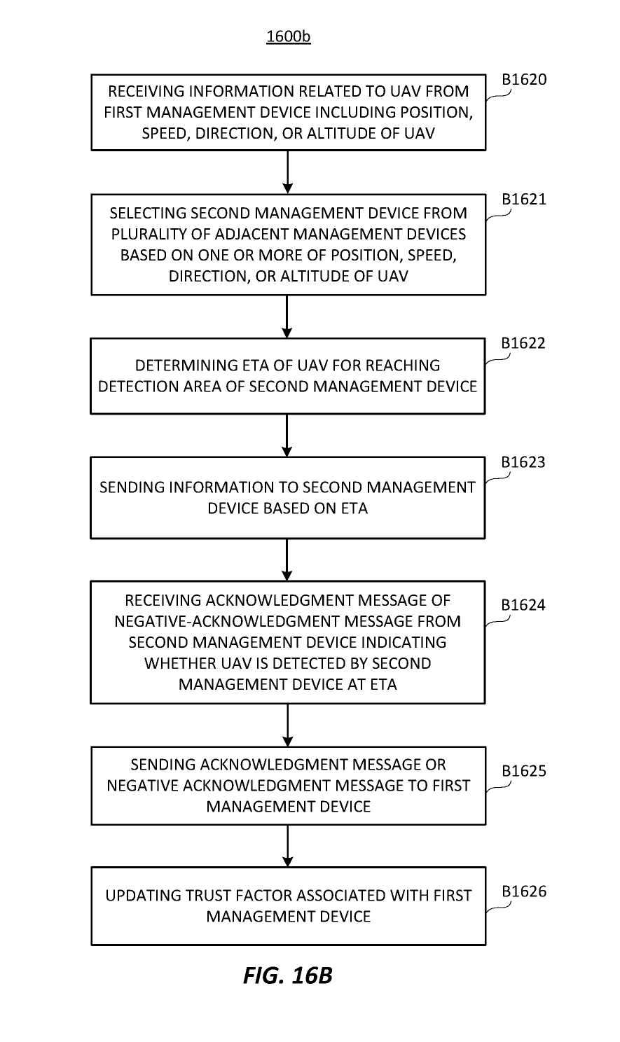

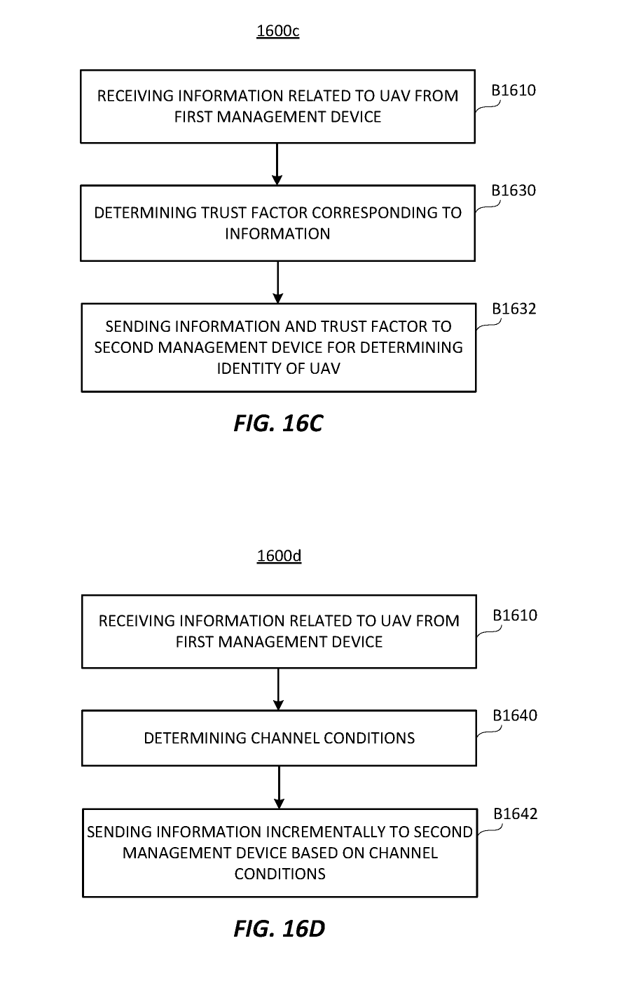

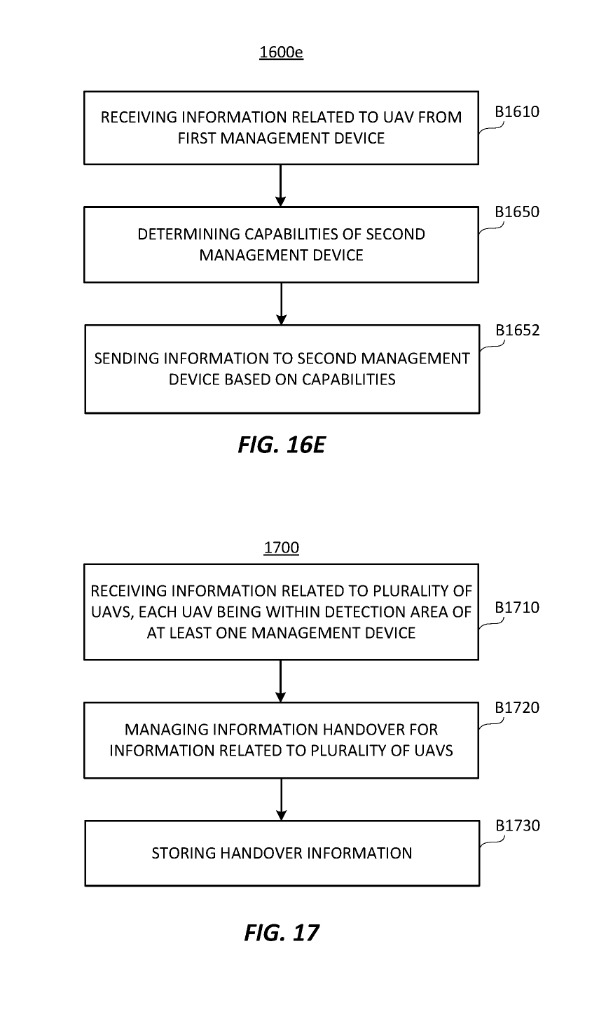

Various examples of methods pertaining to the collaborative UAV detection and management systems 900, 1000, and 1100 are described herein. Particularly, FIGS. 12-13F illustrate examples of methods for managing detection and identification of the UAV 1190 performed by the first detection device 1110. FIGS. 14-15B illustrate examples of methods for managing detection and identification of the UAV 1190 performed by the second detection device 1120. FIGS. 16A-17 illustrate examples of methods for managing detection and identification of the UAV 1190 performed by the central server 1112.

FIG. 12 is a process flow diagram illustrating a method 1200 for managing detection and identification of the UAV 1190 performed by the first detection device 1110 according to various examples. Referring to FIGS. 1-17, the method 1200 may be performed by at least a processor (e.g., the processor 230, 630, or another suitable processor described) and at least one sensor (e.g., the sensors 210a-210n, 512a-512n, 522a-522n, 532a, 532b, 542a, 552a, or another suitable sensor described) of the first detection device 1110 in some examples. The method 1200 may apply to sharing the information via the inter-detection device network link 1121 and sharing the information via the central server 1112.

At block B1210, the processor of the first detection device 1110 may determine the information related to the UAV. The information may include one or more of, but not limited to, (1) sensor data outputted by at least one sensor of the first detection device 1110; (2) identity data such as, but not limited to, the identity data 515-555, output signal 260, identification data 580, or the like indicating the identity of the UAV 1190; (3) the characteristic data 590 indicating one or more of the existence, speed, direction, range, altitude of the UAV 1190, or the like; or (4) secondary data such as, but not limited to, timestamp at which the sensor data, identity data, or characteristic data is determined by the first detection device 1110.

At block B1220, the processor of the first detection device 1110 may send the information to the second detection device 1120 for determining the identity of the UAV 1190. In some examples, the first detection device 1110 may send the information to all neighbor detection devices 1120, 1130, 1140, 1150, and 1160, including the second detection device 1120. In other examples, the first detection device 1110 may select one or more of the neighbor detection devices 1120, 1130, 1140, 1150, and 1160 for sending the information in the manner described. In a first deployment scenario in which the inter-detection device network link 1121 may be used to communicate the information, the information may be sent to the second detection device 1120 via the network link 1121. In a second deployment scenario in which the central server 1112 may be deployed, the information may be sent to the central server 1112 via the network link 1114, and the central server 1112 may send the information to the second detection device 1120 via the network link 1116.

Turning now to FIG. 14, FIG. 14 is a process flow diagram illustrating a method 1400 for managing detection and identification of the UAV 1190 performed by the second detection device 1120 according to various examples. Referring to FIGS. 1-17, the method 1400 may be performed by at least a processor (e.g., the processor 230, 630, or another suitable processor described) of the second detection device 1120. In some examples, at least one sensor (e.g., the sensors 210a-210n, 512a-512n, 522a-522n, 532a, 532b, 542a, 552a, or another suitable sensor described) of the second detection device 1120 may also be used. The method 1400 may apply to sharing the information via the inter-detection device network link 1121 and sharing the information via the central server 1112. The method 1400 may be a response of the second detection device 1120 corresponding to the first detection device 1110 performing the method 1200.

At block B1410, the second detection device 1120 may receive the information originating from the first detection device 1110. In the first deployment scenario in which the inter-detection device network link 1121 is used to communicate the information, the information may be received from the first detection device 1110 via the network link 1121. On the other hand, in the second deployment scenario in which the central server 1112 is deployed, the information may be received from the central server 1112 via the network link 1116.

At block B1420, the processor of the second detection device 1120 may determine the identity of the UAV based, at least in part, on the information originating from the first detection device 1110. Illustrating with a non-limiting example in which the information includes the identity data identifying the UAV 1190, the processor of the second detection device 1120 may set the identity of the UAV 1190 to be the one indicated by the identity data contained in the information. This may be the case if the second detection device 1120 does not support any sensors for detecting and identifying the UAV 1190. This may also be the case if the trust factor of the identity data contained in the information crosses a threshold, indicating that the identity data is trustworthy and that additional detection/identification may not be necessary.

Illustrating with another non-limiting example in which the information includes the sensor data, the processor of the second detection device 1120 may determine additional sensor data outputted by the sensors of the second detection device 1120. The processor of the second detection device 1120 may evaluate the sensor data originating from the first detection device 1110 in combination with the additional sensor data to determine the identity of the UAV 1190. The sensor data obtained from the first detection device 1110 and the additional sensor data obtained by the second detection device 1120 may be evaluated in a manner similar to described with respect to the different identity data 515, 525, 535, 545, and/or 555 of the fusion identification apparatus 500, for example, in the UAV identification method 700. In other words, the first detection device 1110 and the second detection device 1120, when viewed as an entirety, may function similar to the fusion identification apparatus 500. The likelihood of correct identification can be improved given that the types of sensor, accuracies/resolutions of the sensors, and environmental conditions may vary from the first detection device 1110 to the second detection device 1120. Even if the types of sensors, accuracies/resolutions of the sensors, and environmental conditions remain the same from the first detection device 1110 to the second detection device 1120, identifying the UAV 1190 in this manner can at least increase detection monitoring time and sampling size, thus improving the likelihood of correct identification. Such identification example may be applicable when or if the first detection device 1110 cannot provide the identity data identifying the UAV 1190 while the UAV 1190 is within the first detection area 1115 with the appropriate level of confidence due to error, lack of detection monitoring time, inconclusive sensor data, and/or the like.

Turning now to FIG. 16A, FIG. 16A is a process flow diagram illustrating a method 1600a for managing detection and identification of the UAV 1190 performed by the central server 1112 according to various examples. Referring to FIGS. 1-17, the method 1600a may be performed by at least a processor (e.g., the processor 970) of the central server 1112. The method 1600a may apply to sharing the information via the central server 1112. The method 1600a may be a response of the central server 1112 corresponding to the first detection device 1110 performing the method 1200.

At block B1610, the processor 970 of the central server 1112 may receive the information related to the UAV 1190 from the first detection device 1110, for example, via the network link 1114.

At block B1612, the processor 970 of the central server 1112 may select at least one neighbor detection device from detection devices linked to the central server 1112. In some examples, the processor 970 of the central server 1112 may select all neighbor detection devices 1120, 1130, 1140, 1150, and 1160 adjacent to the first detection device 1110, given that the geographical employment configurations of the detection devices may be previously known and stored in the memory 972. In some examples, the processor 970 of the central server 1112 may select one or more of the neighbor detection devices 1120, 1130, 1140, 1150, and 1160 that the UAV 1190 may enter after the first detection area 1115 based on the characteristic data 590 contained in the information received from the first detection device 1110, in the manner described.

At block B1614, the processor 970 of the central server 1112 may send the information related to the UAV to the selected at least one neighbor detection device (e.g., the second detection device 1120). In some examples, the central server 1112 (e.g., the processor 970) may be configured to send the information to the second detection device 1120 directly in response to selecting the second detection device 1120. In some examples, the central server 1112 may be configured to send the information to the second detection device 1112 by sending an identifier associated with the second detection device 1112 to the first detection device 1110 for the first detection device 1110 to send the information to the second detection device 1112.

Referring to FIG. 13A, FIG. 13A is a process flow diagram illustrating a method 1300a for managing detection and identification of the UAV 1190 performed by the first detection device 1110 according to various examples. Referring to FIGS. 1-17, the method 1300a may be performed by at least the processor and at least one sensor of the first detection device 1110 in some examples. The method 1300a may apply to sharing the information via the inter-detection device network link 1121 and sharing the information via the central server 1112. The method 1300a may be a particular implementation of the method 1200.

For instance, determining the information related to the UAV 1190 at block B1210 may include determining one or more of the position, speed, direction, or altitude of the UAV 1190, at block B1310 (e.g., as determined by the methods 400a, 700, 800). One or more of the position, speed, direction, or altitude of the UAV 1190 may be contained in the characteristic data 590 of the UAV 1190. The characteristic data 590 may be obtained based on sensor data of one or more of the sensors 210a-210n, 512a-512n, 522a-522n, 532a, 532b, 542a, 552a, or another suitable sensor in the manner described. The sensor data may capture the movement characteristics 1195 of the UAV 1190 as the characteristic data 590 and may provide the characteristic data 590 corresponding to the movement characteristics 1195.

At block B1312, the processor of the first detection device 1110 may select the second detection device 1120 from a plurality of adjacent detection devices 1120, 1130, 1140, 1150, and 1160 based on one or more of the position, speed, direction, or altitude of the UAV 1190. For instance, based on one or more of the position, speed, direction, or altitude, the processor of the first detection device 1110 may project a path corresponding to the movement characteristics 1195 of the UAV 1190. Given that the path indicates that the UAV 1190 is moving closer to the second detection device 1120 (and the second detection area 1125) than another neighbor detection device 1130, 1140, 1150, or 1160, the second detection device 1120 may be selected. For example, the processor of the first detection device 1110 may determine the path using a geographical knowledge base stored in the memory 972. The geographical knowledge base may include geographical features of Sky Highways, which are designated aerial paths for UAVs.

FIG. 13B is a process flow diagram illustrating a method 1300b for managing detection and identification of the UAV 1190 performed by the first detection device 1110 according to various examples. Referring to FIGS. 1-17, the method 1300b may be performed by at least the processor and at least one sensor of the first detection device 1110 in some examples. The method 1300b may apply to sharing the information via the inter-detection device network link 1121 and sharing the information via the central server 1112. The method 1300b may be a particular implementation of the method 1200.

For instance, processor of the first detection device 1110 may determine the ETA of the UAV 1190 for reaching the detection area (e.g., the second detection area 1125) of the second detection device 1120 at block B1320. The ETA may correspond to a moment in time that the UAV 1190 reaches the second detection area 1125. Illustrating with a non-limiting example, the ETA may be determined using the position, speed, direction, or altitude of the UAV 1190 obtained based on sensor data from one or more of the sensors 210a-210n, 512a-512n, 522a-522n, 532a, 532b, 542a, 552a, or another suitable sensor in the manner described to capture the movement characteristics 1195. Geographical employment configurations for the neighbor detection devices 1120, 1130, 1140, 1150, and 1160 may also be used to determine locations, dimensions, and/or boundaries of the second detection area 1125.

At block B1322, the processor of the first detection device 1110 may send the information to the second detection device 1120 based on the ETA. The information may be sent prior to or at the ETA. Illustrating with a non-limiting example, the information may be sent at a moment in time determined as the ETA minus a time interval. That is, if the ETA is X (e.g., 5:20:16) and the time interval is T (e.g., 2 m), then the information may be sent at X-T (e.g., 5:18:16). Examples of the time interval may include, but not limited to, 15 s, 30 s, 1 m, 2 m, and/or the like. Illustrating with another non-limiting example, the information may be sent within the time interval prior to the ETA. That is, if the ETA is X (e.g., 5:20:16) and the time interval is T (e.g., 2 m), then the information may be sent between X-T (e.g., 5:18:16) and X (e.g., 5:20:16). The transmission times may be adjusted for latency. In some examples, the ETA may be sent with the information to the second manage device 1120.

At block B1324, the first detection device 1110 may receive an acknowledgment message or negative-acknowledgment message from the second detection device 1120 or the control server 1112 indicating whether the UAV 1190 has been detected by the second detection device 1120 at the ETA. The processor of the first detection device 1110 may update its trust factor with respect to the accuracy of the information and/or with respect to determining the ETA based on the acknowledgment message or negative-acknowledgment message received. In particular, receiving the acknowledgment message may improve the trust factor associated with one or more aspects of the first detection device 1110, vice versa.

Tuning to FIG. 15A, FIG. 15A is a process flow diagram illustrating a method 1500a for managing detection and identification of the UAV 1190 performed by the second detection device 1120 according to various examples. Referring to FIGS. 1-17, the method 1500a may be performed by at least the processor and at least one sensor of the second detection device 1120 in some examples. The method 1500a may apply to sharing the information via the inter-detection device network link 1121 and sharing the information via the central server 1112. The method 1500a may be a particular implementation of the method 1400.

For instance, the processor of the second detection device 1120 may determine whether any UAV has been detected at or within a period of time following the ETA, at block B1510. Examples of the period of time may include, but not limited to, 5 s, 10 s, 15 s, 30 s, and/or the like. The ETA may be received along with the information at block B1410 in some examples. In other examples, the time at which the information is received may be deemed to be the ETA. In response to determining that no UAV has been detected at the ETA or within the period of time following the ETA, the processor of the second detection device 1120 may send a negative-acknowledgment message to the first detection device 1110, at block B1520.

On the other hand, in response to determining that at least one UAV has been detected at the ETA or within the period of time following the ETA, the processor of the second detection device 1120 may determine whether the detected at least one UAV is the same as the expected UAV 1190. For example, the processor of the second detection device 1120 may determine the identity of the UAV using mechanisms described herein and compare the result with the identity data contained in the information received from the first detection device 1110. Alternatively or in addition, the processor of the second detection device 1120 may determine whether the correlation between the sensor data of the second detection device 1120 and the sensor date of first detection device 1110 crosses a threshold indicating close correlation.

In response to determining that the detected UAV is not the expected UAV 1190, the processor of the second detection device 1120 may determine information related to the new UAV, at block B1540. Subsequently, the processor of the second detection device 1120 may send the negative-acknowledgment message to the first detection device 1110, at block B1520. On the other hand, in response to determining that the detected UAV is the expected UAV 1190, the processor of the second detection device 1120 may send an acknowledgment message to the first detection device 1110, at block B1550.

FIG. 16B is a process flow diagram illustrating a method 1600b for managing detection and identification of the UAV 1190 performed by the central server 1112 according to various examples. Referring to FIGS. 1-17, the method 1600b may be performed by at least the processor 970 of the central server 1112. The method 1600b may apply to sharing the information via the central server 1112. The method 1600b may be a particular implementation of the method 1600a. The method 1600b may be alternative to the methods 1300a or 1300b in which the first detection device 1110 selects the second detection device 1120 and/or determines the ETA.

At block B1620, the central server 1112 may receive the information related to the UAV 1190 from the first detection device 1110, the information includes the position, speed, direction, or altitude of the UAV 1190. At block B1621, the processor 970 of the central server 1112 may select the second detection device 1120 from the plurality of adjacent detection devices 1120, 1130, 1140, 1150, and 1160 based on one or more of the position, speed, direction, or altitude of the UAV 1190. This may be performed in a manner similar to described with respect to the first detection device 1110 with reference to block B1312.

At block B1622, the processor 970 of the central server 1112 may determine the ETA of the UAV 1190 for reaching the detection area (e.g., the second detection area 1125) of the second detection device 1120. This may be performed by the processor 970 in a manner similar to described with respect to the first detection device 1110 with reference to block B1320. At block B1623, the central server 1112 may send the information to the second detection device 1120 based on the ETA. This may be performed by the processor 970 in a manner similar to described with respect to the first detection device 1110 with reference to block B1322.

At block B1624, the central server 1112 may receive an acknowledgment message or negative-acknowledgment message from the second detection device 1120 indicating whether the UAV 1190 has been detected by the second detection device 1120 at the ETA. At block B1625, the central server 1112 may send the acknowledgment message or negative-acknowledgment message to the first detection device 1110. At block B1626, the processor 970 of the central server 1112 may update the trust factor associated with the first detection device 1110 based on the acknowledgment message or negative-acknowledgment message received from the second detection device 1120.

FIG. 13C is a process flow diagram illustrating a method 1300c for managing detection and identification of the UAV 1190 performed by the first detection device 1110 according to various examples. Referring to FIGS. 1-17, the method 1300c may be performed by at least the processor and at least one sensor of the first detection device 1110 in some examples. The method 1300c may apply to sharing the information via the inter-detection device network link 1121 and sharing the information via the central server 1112. The method 1300c may be a particular implementation of the method 1200.

For instance, at block B1330, the processor of the first detection device 1110 may determine the trust factor corresponding to the information (obtained at block B1210). The trust factor may indicate a level of confidence in the accuracy of the information obtained by the first detection device 1110 and relayed to the second detection device 1120. In some examples, the trust factor may be associated with the ETA (e.g., at block B1324). The trust factor associated with the ETA may be the same as the trust factor associated with the information in some examples. In other examples, the trust factors associated with the ETA and the information may be different trust factors.

Illustrating with a non-limiting example, the trust factor may be determined based on a predetermined value. The predetermined value may represent a designated level of confidence in the accuracy of the information obtained by the first detection device 1110. The predetermined value may be stored. Illustrating with another non-limiting example, the trust factor may be determined dynamically based on a measurement time interval starting when the UAV 1190 enters the first detection area 1115 and ending when the UAV 1190 exits the first detection area 1115. Longer measurement time interval may indicate increased sampling time and sampling size, thus enhanced accuracy can likely result. Therefore, longer measurement time interval may correspond to a trust factor indicating higher level of confidence in the accuracy of the information.

Illustrating with yet another non-limiting example, the trust factor may be determined dynamically based on a distance that the UAV 1190 traveled within the first detection area 1115. Similar to described with respect to the measurement time interval, the sensors of the first detection device 1110 may have improved sampling for detecting aspects of the UAV 1190 as the UAV 1190 travels farther, thus enhancing the accuracy of the information.

Illustrating with yet another non-limiting example, the trust factor may be determined based on types of sensors used by the first detection device 1110 to determine the information. Having some types of sensors (e.g., the audio sensors 210a-210n) known to be more accurate may correspond to an improved level of accuracy as compared to other types of sensors (e.g., the first radar 532a 532b), vice versa. Illustrating with yet another non-limiting example, the trust factor may be determined based on the accuracy of at least one of the sensors used by the first detection device 1110 to determine the information. Higher accuracy may correspond to improved trust factor, vice versa.

Illustrating with yet another non-limiting example, the trust factor may be determined dynamically based on a hysteretic value reflecting historic accuracies of the information outputted by the first detection device 1110. The historic accuracies of the information may be obtained based on feedback from the second detection device 1110 and/or the central server 1112 (for example, the acknowledgment messages and negative-acknowledgment messages). For instance, an acknowledgment message can improve the trust factor, vice versa.

Illustrating with yet another non-limiting example, the trust factor may be determined dynamically based on a time duration since data outputted by at least a sensor of the first detection device 1110 has been obtained, given that accuracy of the sensor data can decay over time. In other words, the trust factor with respect to the sensor data or determined identity of the UAV 1190 based on the sensor data may deteriorate over time.

Illustrating with yet another non-limiting example, the trust factor may be determined dynamically based on environmental conditions within the first detection area 1115. Given that environmental conditions may dynamically change based on time and location, the environmental conditions can bias the trust factor accordingly. If a detection area includes a city center, downtown area, or airport, background noise may become a hindering factor for measuring based on acoustics. Thus, the trust factor for a detection device using acoustics (e.g., the acoustic-based identification apparatuses 200 and 510) may decline while the city center is busy during the day.

The trust factor may be determined based on one or more of the examples described herein. In some examples, the trust factor may be determined based on a weighted or unweighted combination of the examples. In some examples, the trust factor may be determined as the sensor data is being obtained to the first detection device 1110. In other examples, the trust factor may be determined after the sensor data is obtained and prior to the information is sent (for example, based on the ETA described with reference to FIG. 13B). At block B1332, the first detection device 1110 may send the information and the trust factor to the second detection device for determining the identity of the UAV 1190.

Tuning to FIG. 15B, FIG. 15B is a process flow diagram illustrating a method 1500b for managing detection and identification of the UAV 1190 performed by the second detection device 1120 according to various examples. Referring to FIGS. 1-17, the method 1500b may be performed by at least the processor and at least one sensor of the second detection device 1120 in some examples. The method 1500b may apply to sharing the information via the inter-detection device network link 1121 and sharing the information via the central server 1112. The method 1500b may be a particular implementation of the method 1400.

At block B1560, the processor of the second detection device 1120 may determine whether the information needs to be updated. In some examples, the trust factor may be received along with the information from the first detection device 1110 or from the central server 1112 (e.g., at block B1410). In other examples, the trust factor may be determined by the processor of the second detection device 1120 in a manner similar to described with reference to block B1330. Some parameters (e.g., the predetermined value, types of sensors, accuracy of sensors, hysteretic value, environmental conditions, and/or the like) used for determining the trust factor relative to the information originating from the first detection device 1110 may be stored in the memory of the second detection device 1120. The stored parameters may be subject to update from the first detection device 1110 and/or the central server 1112. Some parameters (e.g., the predetermined value, measurement time interval, distance traveled, types of sensors, accuracy of sensors, hysteretic value, environmental conditions, and/or the like) may be sent to the second detection device 1120 from the first detection device 1110 and/or the central server 1112. Such parameters may be referred to as secondary data, included as a part of the information. Particularly, the secondary data may include a timestamp at which the sensor data, identity data, or characteristic data of the UAV 1190 is determined by the first detection device 1110. The processor of the second detection device 1120 may determine the trust factor corresponding to the information by taking into account the decay of the sensor data over time.

The processor of the second detection device 1120 may determine whether the sensor data and/or the identity data included in the information may need to be updated by evaluating the trust factor. In some examples, in response to determining that the trust factor crosses a threshold (indicating a high level of confidence in the information), the information may not need to be updated. On the other hand, in response to determining that the trust factor does not cross the threshold, the information may need to be updated.

At block B1570, the processor of the second detection device 1120 may determine the identity of the UAV 1190 based on the information in response to determining that the information does not need to be updated (B1560:NO). In some examples in which the information includes the identity data, the processor of the second detection device 1120 may adopt the identity of the UAV 1190 as indicated in the identity data, without further measurements. In some examples in which the information includes the sensor data, the processor of the second detection device 1120 may determine the identity of the UAV 1190 based solely on the sensor data originating from the first detection device 1110. In other examples, to bolster the confidence level even further, the information received from the first detection device 1110 and the sensor data originating from the second detection device 1120 may be used in combination to determine the identity of the UAV 1190 even though the information does not need to be updated (B1560:NO).

At block B1580, the processor of the second detection device 1120 may update the information in response to determining that the information needs to be updated (B1560:YES). That is, the processor of the second detection device 1120 may configure the sensors of the second detection device 1120 to perform measurements with respect to the UAV 1190. At block B1590, the processor of the second detection device 1120 may determine the identity of the UAV 1190 based on the updated information (e.g., data from measurements performed by the second detection device 1120).

In some examples, the information received from the first detection device 1110 may be disregarded completely. The identity of the UAV 1190 may be determined solely based on the sensor data originating from the second detection device 1120. This may be triggered, for example, by the trust factor crossing another threshold indicating that the information received from the first detection device 1110 is untrustworthy. In some examples, the information received from the first detection device 1110 and the sensor data originating from the second detection device 1120 may be used in combination to determine the identity of the UAV 1190. In such a scenario, the information received from the first detection device 1110 may be weighted based on the trust factor. That is, the information received from the first detection device 1110 may be assigned more weight if the trust factor indicates that such information is more trustworthy, vice versa.

FIG. 16C is a process flow diagram illustrating a method 1600c for managing detection and identification of the UAV 1190 performed by the central server 1112 according to various examples. Referring to FIGS. 1-17, the method 1600c may be performed by at least the processor 970 of the central server 1112. The method 1600c may be alternative to the methods 1300c in which the first detection device 1110 determines the trust factor. The method 1600c may apply to sharing the information via the central server 1112. The method 1600c may be a particular implementation of the method 1600a.

At block B1630, the processor 970 of the central server 1112 may determine the trust factor corresponding to the information upon receiving the information at block B1610. In some examples, the trust factor may be received along with the information from the first detection device 1110 (e.g., at block B1610). In other examples, the trust factor may be determined by the processor 970 of the central server 1112 in a manner similar to described with reference to blocks B1330 and B1560. For instance, some parameters (e.g., the predetermined value, types of sensors, accuracy of sensors, hysteretic value, environmental conditions, and/or the like) used for determining the trust factor relative to the information originating from the first detection device 1110 may be stored in the memory 972 of the central server 1112. The stored parameters may be subject to update from the first detection device 1110. Some parameters (e.g., the predetermined value, measurement time interval, distance traveled, types of sensors, accuracy of sensors, hysteretic value, environmental conditions, and/or the like) may be received from the first detection device 1110. Such parameters may be referred to as the secondary data, included as a part of the information. Particularly, the secondary data may include a timestamp at which the sensor data, identity data, or characteristic data of the UAV 1190 is determined by the first detection device 1110. The processor 970 of the central server 1112 may determine the trust factor corresponding to the information by taking into account the decay of the sensor data over time.

At block B1632, the central server 1112 may send the information and the trust factor to the second detection device 1120 for determining the identity of the UAV 1190.

FIG. 13D is a process flow diagram illustrating a method 1300d for managing detection and identification of the UAV 1190 performed by the first detection device 1110 according to various examples. Referring to FIGS. 1-17, the method 1300d may be performed by at least the processor and at least one sensor of the first detection device 1110 in some examples. The method 1300d may apply to sharing the information via the inter-detection device network link 1121 and sharing the information via the central server 1112. The method 1300d may be a particular implementation of the method 1200.

For instance, at block B1340, the processor of the first detection device 1110 may determine the information related to a plurality of UAVs, including the information related to the UAV 1190 at block B1210. Each of the plurality of UAVs may be determined in a manner similar to described with respect to block B1210.

At block B1342, the processor of the first detection device 1110 may determine the channel conditions, for example, with respect to the network link 1121 (for sharing the information via the inter-detection device network link 1121) and/or network link 1114 (for sharing the information via the central server 1112). The channel conditions may depend on channel throughput, congestion status, Quality of Service (QoS), a combination thereof, and/or the like.

At block B1344, the first detection device 1110 may send the information incrementally to the second detection device 1120 based on the channel conditions. That is, instead of sending the information via the network link 1121 and/or the network link 1114 in a single instance, the information may be sent piecemeal in segments to accommodate limited channel conditions. The information may be divided into segments based on number of UAVs, ETAs (determined at block B1320 of FIG. 13B) of each of the UAVs, types of sensors, accuracies of the sensors, and/or the like. Sequence numbers, tags, timestamps, and/or other identifiers (indicating how the data in different segments should be assembled) may be sent with each segment.

Illustrating with a non-limiting example, the channel conditions may allow information for a first number of UAVs to be send periodically (e.g., every 10 ms, 50 ms, 200 ms, 1 s, 5 s, or the like). Thus, the processor of the first detection device 1110 may divide information related to the total number of UAVs into segments. Each segment may include information related to the first number of UAVs.

Illustrating with another non-limiting example, a segment sent earlier in time may include the information related to UAVs with ETAs earlier than ETAs of other UAVs sent in segments at a later time. Thus, the first detection device 1110 may prioritize (e.g., send earlier in time) the information of UAVs leaving the first detection area 1115 and/or entering another detection area (e.g., the second detection area 1125) earlier than other UAVs within the first detection area 1115.

Illustrating with yet another non-limiting example, the first detection device 1110 may send sensor data obtained by a first type of sensors (e.g., the audio sensors 210a-210n and 512a-512n) for one or more UAVs in a first segment before sending sensor data obtained by a second type of sensors (e.g., the visual sensors 522a-522n) for the same UAVs in a second segment sent in a subsequent segment. Thus, the first detection device 1110 may prioritize (e.g., send earlier in time) information obtained by some types of sensors. The prioritized types of sensors may generally have higher accuracy as compared to other types of sensors in some examples.

Illustrating with yet another non-limiting example, the first detection device 1110 may send sensor data obtained by a sensor with higher accuracy and/or reliability for one or more UAVs in a first segment before sending sensor data obtained by a sensor with lower accuracy and/or reliability for the same UAVs in a second segment sent in a subsequent segment. Thus, the first detection device 1110 may prioritize (e.g., send earlier in time) information obtained by sensors that are more accurate.

FIG. 16D is a process flow diagram illustrating a method 1600d for managing detection and identification of the UAV 1190 performed by the central server 1112 according to various examples. Referring to FIGS. 1-17, the method 1600d may be performed by at least the processor 970 of the central server 1112. The method 1600d may be alternative or additional to the methods 1300d in which the first detection device 1110 takes into account the network conditions. The method 1600d may apply to sharing the information via the central server 1112. The method 1600d may be a particular implementation of the method 1600a.

For instance, at block B1640, the processor 970 of the central server 1112 may determine the channel conditions. The channel conditions may be determined with respect to the network link 1116. The channel conditions may be determined in a similar manner as described with respect to block B1342.

At block B1642, the central server 1112 may send the information incrementally to the second detection device 1120 (via the network link 1116) based on the channel conditions. For instance, the central server 1112 may divide the information receive from the first detection device 1110 into segments based on the number of UAVs, ETAs (determined at block B1622 of FIG. 16B) of each of the UAVs, types of sensors, accuracies of the sensors, and/or the like in the manner described with respect to block B1344. One or more parameters, such as, but not limited to, the number of UAVs, ETAs of the UAVs, types of sensors, accuracies of the sensors, and/or the like may be received from the first detection device 1110.

FIG. 13E is a process flow diagram illustrating a method 1300e for managing detection and identification of the UAV 1190 performed by the first detection device 1110 according to various examples. Referring to FIGS. 1-17, the method 1300e may be performed by at least the processor and at least one sensor of the first detection device 1110 in some examples. The method 1300e may apply to sharing the information via the inter-detection device network link 1121 and sharing the information via the central server 1112. The method 1300e may be a particular implementation of the method 1200.

For instance, at block B1340, the processor of the first detection device 1110 may determine one or more of position, speed, direction, or altitude of the UAV 1190 as a part of determining the information related to the UAV 1190. At block B1352, the processor of the first detection device 1110 may determine an expected time that the UAV 1190 will remain within the first detection area 1115 and/or expected distance that the UAV 1190 will travel within the first detection area 1115. For instance, based on one or more of the position, speed, direction, or altitude, the processor of the first detection device 1110 may project a path corresponding to the movement characteristics 1195 of the UAV 1190. The time it takes to travel the path may be the expected time. The length of the path may be the expected distance.

At block B1354, the processor of the first detection device 1110 may prioritize obtaining at least one type of information based on the expected time and/or expected distance. In some scenarios, a UAV may transverse the first detection area 1115 in less time or distance as compared to another UAV, depending on the paths that the UAVs take. Thus, types of information may be selectively determined based on the expected time and/or expected distance to optimize identification. Some types of sensors may excel at outputting correct data with longer sampling time and/or sampling size, while other types of data can output correct data with relatively shorter sampling time and/or sampling size.

Illustrating with a non-limiting example, sensor data (e.g., acoustic data or visual data) with respect to a first type of sensors (e.g., audio sensors 210a-210n and 512a-512n and visual sensors 522a-522n) may be obtained for a first UAV corresponding to a first expected time and/or first expected distance. Sensor data (e.g., radar data) with respect to a second type of sensors (e.g., radars 532a and 532b) may be obtained for a second UAV corresponding to a second expected time and/or second expected distance. The first expected time may be longer than the second expected time. The first expected distance may be longer than the second expected distance. Such mechanism can likewise be implemented for other types of sensors.

FIG. 13F is a process flow diagram illustrating a method 1300f for managing detection and identification of the UAV 1190 performed by the first detection device 1110 according to various examples. Referring to FIGS. 1-17, the method 1300f may be performed by at least the processor and at least one sensor of the first detection device 1110 in some examples. The method 1300f may apply to sharing the information via the inter-detection device network link 1121 and sharing the information via the central server 1112. The method 1300f may be a particular implementation of the method 1200.

For instance, at block B1360, the processor of the first detection device 1110 may select the second detection device 1120 from the plurality of adjacent detection devices 1120, 1130, 1140, 1150, and 1160. Illustrating with a non-limiting example, the second detection device 1120 may be selected in a manner similar to described with respect to blocks B1310 and B1312 of FIG. 13A. In alternative examples, the first detection device 1110 may send the information to all adjacent detection devices 1120, 1130, 1140, 1150, and 1160.

At block B1362, the processor of the first detection device 1110 may determine capabilities of the second detection device 1120. The capabilities may include one or more of types of sensors of the second detection device 1120, processing power of the second detection device, and/or the like. In some examples, the first detection device 1110 may send a request to the second detection device 1120 for obtaining the capabilities information. The first detection device 1110 may receive a response indicating the capabilities information from the second detection device 1120 pursuant to the request. In some examples, the capabilities information of the second detection device 1120 may be stored in the memory of the first detection device 1110.

At block B1364, the first detection device 1110 may send the information to the second detection device 1120 based on the capabilities of the second detection device 1120. Illustrating with a non-limiting example, the first detection device 1110 may send a portion of the information corresponding to the types of sensors of the second detection device 1120. That is, in response to determining that only a first type of sensors (e.g., audio sensors 210a-210n) is provided to the second detection device 1120, the first detection device 1110 may send only the acoustic data determined by the same first type of sensors of the first detection device 1110. This allows the second detection device 1120 to perform correlations based on the same type of data from both the first detection device 1110 and the second detection device 1120, for improved confidence level while reducing processing and communication costs of transmitting data that cannot be directly correlated.

Illustrating with another non-limiting example, the first detection device 1110 may send a portion of the information capable of being processed with the processing power of the second detection device 1120. That is, the first detection device 1110 may send only the sensor data that can be processed by the second detection device 1120 without imposing a processing bottleneck at the second detection device 1120.

FIG. 16E is a process flow diagram illustrating a method 1600e for managing detection and identification of the UAV 1190 performed by the central server 1112 according to various examples. Referring to FIGS. 1-17, the method 1600e may be performed by at least the processor 970 of the central server 1112. The method 1600e may be alternative to the methods 1300 in which the first detection device 1110 takes into account the capabilities of the second detection device 1120. The method 1600e may apply to sharing the information via the central server 1112. The method 1600e may be a particular implementation of the method 1600a.

For instance, at block B1650, the processor 970 of the central server 1112 may determine the capabilities of the second detection device 1120. In some examples, the central server 1112 may send a request to the second detection device 1120 for obtaining capabilities information. The central server 1112 may receive a response indicating the capabilities information from the second detection device 1120 pursuant to the request. In some examples, the capabilities information of the second detection device 1120 may be stored in the memory 972 of the central server 1112.

At block B1652, the central server 1112 may send the information to the second detection device 1120 based on the capabilities of the second detection device 1120 in a manner similar to described with respect to block B1364.

FIG. 17 is a process flow diagram illustrating a method 1700 for managing detection and identification of the UAV 1190 performed by the central server 1112 according to various examples. Referring to FIGS. 1-17, the method 1700 may be performed by at least the processor 970 of the central server 1112. The method 1700 may apply to sharing the information via the central server 1112.

At block B1710, the central server 1112 may receive the information related to a plurality of UAVs, each UAV being within a detection area (e.g., the first detection area 1115) of at least one detection device (e.g., the first detection device 1110). For instance, the information related to each UAV (e.g., the UAV 1190) may be received in a manner similar to described with respect to blocks B1610 and B1620.

At block B1720, the central server 1112 may manage information handover for information related to the plurality of UAVs. For instance, the information handover, for example, from the first detection device 1110 to the second detection device 1120, may be managed in a manner similar to described with respect to one or more of blocks B1612, B1614, B1621-B1626, B1630, B1632, B1640, B1642, B1650, or B1652. In some examples, the processor 970 of the central server 1112 may centrally determine handover targets (e.g., the second detection device 1120), manage trust factors for each information source (e.g., the first detection device 1110), manage ETAs of the UAVs, control information flow based on channel conditions and/or handover target capabilities, and/or the like. The central server 1112 may perform the described functions by virtual of connecting to all detection devices and may be therefore well-positioned to leverage information learned from each of the detection devices.

At block B1730, the central server 1112 may store the handover information in the memory 972.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present invention. Various modifications to these examples will be readily apparent to those skilled in the art, and the generic principles defined herein may be applied to some examples without departing from the spirit or scope of the invention. Thus, the present invention is not intended to be limited to the examples shown herein but is to be accorded the widest scope consistent with the following claims and the principles and novel features disclosed herein.

What is claimed is:

1. A method for managing detection and identification of an Unmanned Aerial Vehicle (UAV), the method comprising:
determining, by a first detection device configured to detect the UAV in a first detection area, information related to the UAV; and
sending, by the first detection device, the information to a second detection device configured to detect the UAV in a second detection area for determining an identity of the UAV.

2. The method of claim 1, wherein the first detection area is adjacent to or overlapping with the second detection area.

3. The method of claim 1, further comprising:
determining one or more of a position, speed, direction, or altitude of the UAV; and
selecting the second detection device from a plurality of adjacent detection devices based on the one or more of the position, speed, direction, or altitude of the UAV.

4. The method of claim 1, further comprising determining an Estimated Time of Arrival (ETA) of the UAV for reaching the second detection area of the second detection device, wherein the information is sent to the second detection device based on the ETA.

5. The method of claim 1, further comprising:
selecting the second detection device from a plurality of adjacent detection devices; and
determining capabilities of the second detection device, wherein
the information is sent to the second detection device based on the capabilities of the second detection device.

6. The method of claim 5, wherein:
the capabilities comprise at least one of:
(1) types of sensors of the second detection device; or
(2) processing power of the second detection device; and
sending the information to the second detection device based on the capabilities of the second detection device comprises at least one of:
(1) sending a portion of the information corresponding to the types of sensors of the second detection device; or
(2) sending a portion of the information capable of being processed with the processing power of the second detection device.

7. The method of claim 1, wherein the information comprises at least one of:
(1) sensor data outputted by at least one sensor of the first detection device;
(2) identity data indicating a determined identity based on the sensor data;
(3) characteristic data of the UAV, wherein the characteristic data comprises at least one of speed, direction, range, or altitude of the UAV; or
(4) secondary data, wherein the secondary data comprises a timestamp at which the sensor data, identity data, or characteristic data is determined.

8. A method for managing detection and identification of an Unmanned Aerial Vehicle (UAV) by a second detection device, which is configured to detect the UAV in a second detection area, based on information sent by a first detection device, which is configured to detect the UAV in a first detection area, the method comprising:
receiving, by the second detection device, the information related to the UAV from the first detection device; and
determining, by the second detection device, an identity of the UAV based, at least in part, on the information.

9. The method of claim 8, further comprising:
receiving an Estimated Time of Arrival (ETA) of the UAV for reaching the second detection area of the second detection device;
determining whether any UAV has been detected at the ETA; and
determining whether a detected UAV and the UAV corresponding to the ETA are the same.

10. The method of claim 8, wherein determining the identity of the UAV is based, at least in part, on the information and a trust factor corresponding to the information.

11. The method of claim 10, wherein the trust factor is based on one or more of:
(1) a predetermined value;
(2) a measurement time interval starting when the UAV enters the first detection area of the first detection device and ending when the UAV exits the first detection area of the first detection device;
(3) a distance that the UAV traveled within the first detection area of the first detection device;
(4) types of sensors used by the first detection device to determine the information;
(5) accuracy of at least one of the sensors used by the first detection device to determine the information;
(6) a hysteretic value reflecting historic accuracies of the information outputted by the first detection device previously;
(7) a time duration since data outputted by at least one of the sensors has been obtained; and
(8) environmental conditions within the first detection area of the first detection device.

12. The method of claim 10, further comprising determining whether the information needs to be updated based on the trust factor by determining whether the trust factor crosses a threshold.

13. A method for managing detection and identification of an Unmanned Aerial Vehicle (UAV) by a central server connected to a first detection device and a plurality of detection devices, the method comprising:
receiving, by the central server, information related to the UAV from the first detection device;
selecting, by the central server, a second detection device from the plurality of detection devices; and
sending, by the central server, the information to the second detection device.

14. The method of claim 13, further comprising:
receiving data indicating at least one of position, speed, direction, or altitude of the UAV from the first detection device; and
wherein selecting the second detection device the at least one neighbor detection device is based on the at least one of position, speed, direction, or altitude of the UAV.

15. The method of claim 14, further comprising determining an Estimated Time of Arrival (ETA) of the UAV for reaching a detection area of the second detection device based on the at least one of position, speed, direction, or altitude of the UAV.

16. The method of claim 15, wherein the information is sent to the second detection device based on the ETA.

17. The method of claim 15, wherein the second detection device is selected based on the ETA.

18. The method of claim 13, further comprising:
sending, with the information, a trust factor associated with the information to the second detection device.

19. The method of claim 13, wherein the information is sent to the second detection device based on a trust factor associated with the information.

20. The method of claim 19, wherein the trust factor is based on one or more of:
(1) a predetermined value;
(2) a measurement time interval starting when the UAV enters the first detection area of the first detection device and ending when the UAV exits the first detection area of the first detection device;
(3) a distance that the UAV traveled within the first detection area of the first detection device;
(4) types of sensors used by the first detection device to determine the information;
(5) accuracy of at least one of the sensors used by the first detection device to determine the information;
(6) a hysteretic value reflecting historic accuracies of the information outputted by the first detection device previously;
(7) a time duration since data outputted by at least one of the sensors has been obtained; and
(8) environmental conditions within the first detection area of the first detection device.

21. The method of claim 20, further comprising determining whether the information needs to be updated based on the trust factor by determining whether the trust factor crosses a threshold.

22. The method of claim 13, wherein the second detection device is selected based on capabilities of the second detection device.

23. An apparatus for managing detection and identification of an Unmanned Aerial Vehicle (UAV); comprising:
a central server connected to a first detection device and a plurality of detection devices, wherein the central server is configured to:
receive, by the central server, information related to the UAV from the first detection device;
select, by the central server, a second detection device from the plurality of detection devices connected to the central server; and
send, by the central server, the information to the second detection device.

24. The apparatus of claim 23, wherein the central server is further configured to:
receive data indicating at least one of position, speed, direction, or altitude of the UAV from the first detection device; and
wherein selecting the second detection device is based on the at least one of position, speed, direction, or altitude of the UAV.

25. The apparatus of claim 24, wherein the central server is further configured to determine an Estimated Time of Arrival (ETA) of the UAV for reaching a detection area of the second detection device based on the at least one of position, speed, direction, or altitude of the UAV.

26. The apparatus of claim 25, wherein the information is sent to the second detection device based on the ETA.

27. The apparatus of claim 25, wherein the second detection device is selected based on the ETA.

28. The apparatus of claim 23, wherein the second detection device is selected based on capabilities of the second detection device.

29. The apparatus of claim 23, wherein the central server is further configured to send, with the information, a trust factor associated with the information to the second detection device.

30. The apparatus of claim 23, wherein the information is sent to the second detection device based on a trust factor associated with the information.
